(19) United States
(12) Patent Application Publication
(10) Pub. No.: US 2016/0323425 A1
(43) Pub. Date: Nov. 3, 2016

(54) ENHANCED VOICE SERVICES (EVS) IN 3GPP2 NETWORK

(71) Applicant: QUALCOMM Incorporated, San Diego, CA (US)

(72) Inventors: Roozbeh Atarius, San Diego, CA (US); Alireza Ryan Heidari, Encinitas, CA (US); Min Wang, San Diego, CA (US); Daniel Jared Sinder, San Diego, CA (US); John Wallace Nasielski, San Diego, CA (US); Vivek Rajendran, San Diego, CA (US)

(21) Appl. No.: 14/861,131

(22) Filed: Sep. 22, 2015

Related U.S. Application Data
(60) Provisional application No. 62/154,559, filed on Apr. 29, 2015.

(51) Int. Cl. H04L 29/08; G10L 19/16; G10L 19/005; H04W 76/04

(52) U.S. Cl. CPC H04L 69/324; H04W 76/048; G10L 19/167; G10L 19/005; H04W 84/042

(57) ABSTRACT

In various aspects, the disclosure provides for Enhanced Voice Services (EVS) encoding, including encoding an audio signal to obtain an encoded audio signal and a bitrate associated with the encoded audio signal; establishing a source format for the encoded audio signal based on the bitrate; reformatting the encoded audio signal with a pre-selected pattern to generate a packet, wherein a capacity of the packet is based on the source format. And, in various other aspects, the disclosure provides for EVS decoding, including obtaining a data rate associated with a packet; discarding one or more pre-selected patterns from the packet to recover an encoded audio signal based on the data rate; and decoding the encoded audio signal to generate a decoded audio signal.

### CROSS-REFERENCE TO RELATED APPLICATIONS

This application claims priority to and the benefit of provisional patent application No. 62/154,559 filed in the United States Patent and Trademark Office on 29 Apr. 2015, the entire content of which is incorporated herein by reference.

### FIELD

Aspects of the present disclosure relate generally to wireless communication systems, and more particularly, to Enhanced Voice Services in a 3GPP2 wireless network.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports Enhanced Voice Services (EVS) to provide higher quality audio services.

Another example of such a network is based on a cdma2000 system, a third generation (3G) mobile phone technology supported by the 3rd Generation Partnership Project 2 (3GPP2). The cdma2000 system is the successor to cdma one and supports a code division multiple access (CDMA) air interface. As the demand for mobile broadband access continues to increase, research and development continue to advance technologies not only to meet the growing demand for mobile broadband access, but to advance and enhance the user experience with mobile communications.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

According to various aspects of the disclosure, a method for Enhanced Voice Services (EVS) encoding, includes encoding an audio signal to obtain an encoded audio signal and a bitrate associated with the encoded audio signal; establishing a source format for the encoded audio signal based on the bitrate; reformatting the encoded audio signal with a pre-selected pattern to generate a packet, wherein a capacity of the packet is based on the source format. In various examples, the method further includes generating the audio signal, wherein the audio signal is generated by one of the following: a microphone, an audio player, a transducer or a speech synthesizer; modulating the packet to generate a modulated waveform; and transmitting the modulated waveform to an audio destination, wherein the audio destination is an audio consumer.

According to various aspects of the disclosure, a method for Enhanced Voice Services (EVS) decoding, including obtaining a data rate associated with a packet; discarding one or more pre-selected patterns from the packet to recover an encoded audio signal based on the data rate; and decoding the encoded audio signal to generate a decoded audio signal. In various examples, the method further includes receiving a signal, and converting the received signal to the packet; and sending the decoded audio signal to an audio destination, wherein the audio destination is one of the following: a speaker, a headphone, a recording device or a digital storage device.

According to various aspects of the disclosure, a method for interworking, including receiving an encoded audio signal and a bitrate associated with the encoded audio signal from a first network without discontinuous transmission (DTX) support; discarding a pre-selected pattern from the encoded audio signal to generate a packet for a second network with DTX support, wherein the pre-selected pattern is based on the DTX support; and sending the packet to the second network.

According to various aspects of the disclosure, a method for interworking, including receiving an encoded audio signal and a bitrate associated with the encoded audio signal from a first network with discontinuous transmission (DTX) support; reformatting the encoded audio signal with a pre-selected pattern to generate a packet for a second network without DTX support, wherein the pre-selected pattern is based on the DTX support; and sending the packet to the second network.

According to various aspects of the disclosure, an apparatus for Enhanced Voice Services (EVS) encoding, including means for encoding an audio signal to obtain an encoded audio signal and a bitrate associated with the encoded audio signal; means for establishing a source format for the encoded audio signal based on the bitrate; and means for reformatting the encoded audio signal with a pre-selected pattern to generate a packet, wherein a capacity of the packet is based on the source format. In various examples, the apparatus further includes means for modulating the packet to generate a modulated waveform; and means for transmitting the modulated waveform to an audio destination, wherein the audio destination is an audio consumer.

According to various aspects of the disclosure, an apparatus for Enhanced Voice Services (EVS) decoding, including means for obtaining a data rate associated with a packet; means for discarding one or more pre-selected patterns from the packet to recover an encoded audio signal based on the data rate; and means for decoding the encoded audio signal to generate a decoded audio signal. In various examples, the apparatus further includes means for sending the decoded audio signal to an audio destination, wherein the audio destination is one of the following: a speaker, a headphone, a recording device or a digital storage device.

According to various aspects of the disclosure, an apparatus for interworking, including means for receiving an encoded audio signal and a bitrate associated with the encoded audio signal from a first network without discontinuous transmission (DTX) support; means for discarding a pre-selected pattern from the encoded audio signal to generate a packet for a second network with DTX support, wherein the pre-selected pattern is based on the DTX support; and means for sending the packet to the second network.

According to various aspects of the disclosure, an apparatus for interworking, including means for receiving an encoded audio signal and a bitrate associated with the encoded audio signal from a first network with discontinuous transmission (DTX) support; means for reformatting the encoded audio signal with a pre-selected pattern to generate a packet for a second network without DTX support, wherein the pre-selected pattern is based on the DTX support; and means for sending the packet to the second network.

According to various aspects of the disclosure, a computer-readable storage medium storing computer executable code, operable on a device including at least one processor; a memory for storing a sharing profile, the memory coupled to the at least one processor; and the computer executable code including instructions for causing the at least one processor to encode an audio signal to obtain an encoded audio signal and a bitrate associated with the encoded audio signal; instructions for causing the at least one processor to establish a source format for the encoded audio signal based on the bitrate; and instructions for causing the at least one processor to reformat the encoded audio signal with a pre-selected pattern to generate a packet, wherein a capacity of the packet is based on the source format.

According to various aspects of the disclosure, a computer-readable storage medium storing computer executable code, operable on a device including at least one processor; a memory for storing a sharing profile, the memory coupled to the at least one processor; and the computer executable code including instructions for causing the at least one processor to obtain a data rate associated with a packet; instructions for causing the at least one processor to discard one or more pre-selected patterns from the packet to recover an encoded audio signal based on the data rate; and instructions for causing the at least one processor to decode the encoded audio signal to generate a decoded audio signal.

These and other aspects of the present disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the present disclosure discussed herein. In similar fashion, while exemplary embodiments may be discussed below as device, system, or method embodiments it should be understood that such exemplary embodiments may be implemented in various devices, systems, and methods.

### BRIEF DESCRIPTION OF THE DRAWINGS

FIG. 1 is a graphical representation of the speech codecs for 3GPP and 3GPP2.

FIG. 2 illustrates examples of four supported bandwidths for Enhanced Voice Services (EVS).

FIG. 3 is a chart illustrating examples of music performances for EVS.

FIG. 4 illustrates an example of an EVS Super Wideband (SWB) channel aware mode (ch-aw mode) at 13.2 kbps.

FIG. 5 is a chart illustrating examples of degradation mean opinion score (DMOS) for different error scenarios for three example codecs.

FIG. 6a illustrates an example of a Forward Fundamental Channel (F-FCH) for cdma2000 1×.

FIG. 6b illustrates an example of a Reverse Fundamental Channel (R-FCH) for cdma2000 1×.

FIG. 7 is a diagram conceptually illustrating an example of EVRC family of codecs mode structures.

FIGS. 8a, 8b & 8c illustrate an example of a table showing Service Option 73 encoding rate control parameters.

FIG. 9a illustrates an example of EVS 5.9 frames zero padded into existing Enhanced Variable Rate Codec (EVRC) family of codecs frames.

FIG. 9b illustrates a first example of interworking between a first network and a second network.

FIG. 9c illustrates a second example of interworking between a first network and a second network.

FIG. 10 is a flow chart illustrating an exemplary method for Enhanced Voice Services (EVS) encoding compatibility in a non-native EVS system in accordance with some aspects of the present disclosure.

FIG. 11 is a flow chart illustrating an exemplary method for Enhanced Voice Services (EVS) decoding compatibility in a non-native EVS system in accordance with some aspects of the present disclosure.

FIG. 12 is a diagram conceptually illustrating an example of a hierarchical network architecture with various wireless communication networks.

FIG. 13 is a chart illustrating an example comparison of average rate contributions for both EVS and a cdma2000 1× advanced rate vocoder.

FIG. 14 is a chart illustrating an example of EVS-WB 5.9 speech quality compared to other vocoders.

FIG. 15 is a block diagram illustrating an example of a hardware implementation for an apparatus employing a processing system.

FIG. 16a is a block diagram conceptually illustrating an example of a telecommunications system based on 3GPP.

FIG. 16b is a block diagram conceptually illustrating an example of a telecommunications system based on 3GPP2.

FIG. 17 is a conceptual diagram illustrating an example of an access network.

FIG. 18 is a conceptual diagram illustrating an example of a radio protocol architecture for the user and control plane.

FIG. 19 is a block diagram conceptually illustrating an example of a base station in communication with a UE in a telecommunications system.

FIG. 20 is a conceptual diagram illustrating a simplified example of a hardware implementation for an apparatus employing a processing circuit that may be configured to perform one or more functions in accordance with aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In wireless communication systems, a speech coder at a transmitter and a speech decoder at a receiver provide an efficient digital representation of a speech signal. Efficiency relates to a bit rate, i.e., average number of bits per unit time, used to represent the speech signal to a mean opinion score (MOS). In various examples, the MOS is a measure of the intelligibility of the encoded speech signal as rated by a group of trained listeners.

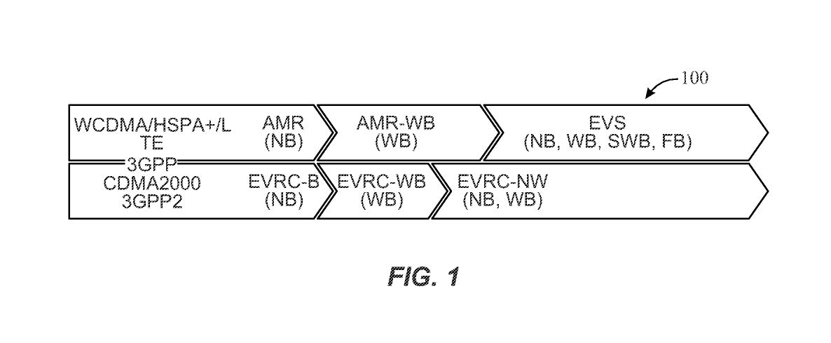

FIG. 1 is a graphical representation of the speech codecs 100 for 3GPP and 3GPP2. FIG. 1 illustrates the evolution of the speech codecs for 3GPP and for 3GPP2. The evolution of 3GPP speech codecs has evolved from Adaptive Multi-Rate (AMR) to Adaptive Multi-Rate Wideband (AMR-WB) and to EVS (with four supported bandwidths). The evolution of 3GPP2 speech codecs has evolved from Enhanced Variable Rate Codec B (EVRC-B) to Enhanced Variable Rate Codec-Wideband (EVRC-WB) and to Enhanced Variable Rate Codec-Narrowband-Wideband (EVRC-NW). As shown in FIG. 1, EVS is included in the speech codecs for 3GPP, but not for 3GPP2.

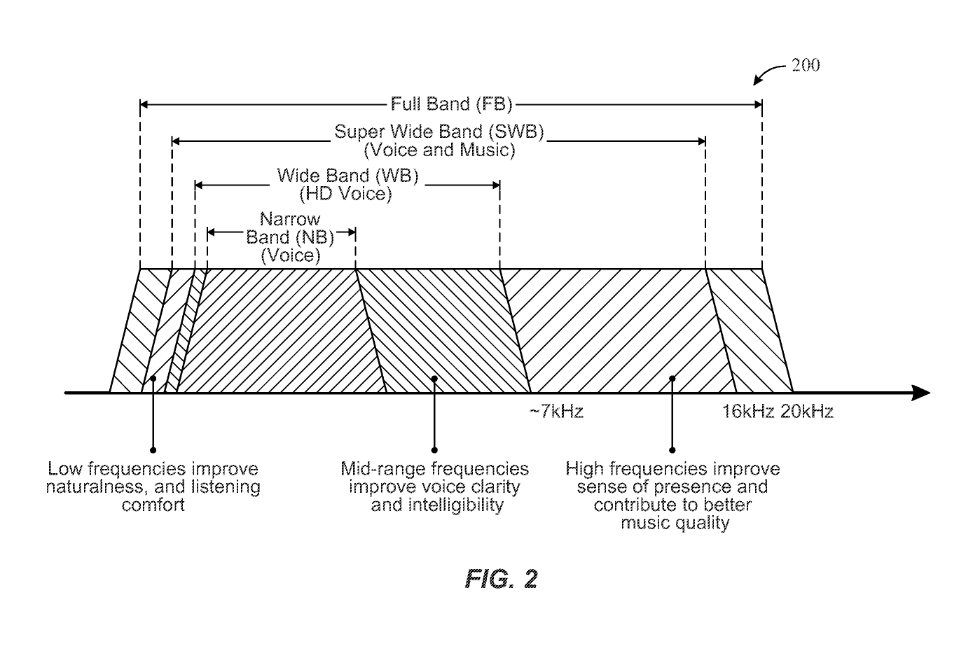

FIG. 2 illustrates examples of four supported bandwidths 200 for Enhanced Voice Services (EVS). Shown in FIG. 2 are supported bandwidths over an audio frequency range up to 20 kHz for four modes in EVS. The four supported bandwidths illustrated in FIG. 2 are: narrowband (NB); wideband (WB), super wideband (SWB) and full band (FB). In various examples, NB supports voice, WB supports high definition (HD) voice, SWB supports voice (including HD voice) and music and FB supports voice (including HD voice) and high definition (HD) music. In various examples, EVS supports a wide range of audio frequencies with the following attributes: a) the low-range frequencies may improve naturalness and listening comfort; b) the mid-range frequencies may improve voice clarity and intelligibility; and c) the high-range frequencies may improve sense of presence and contribute to better music quality.

Table 1 illustrates examples of Enhanced Voice Services (EVS) bitrates and supported bandwidths.

TABLE 1

| EVS Bitrates | Supported | |
|---|---|---|
| (kbps) | Bandwidths | Notes |
| 5.9 (SC-VBR) | NB, WB | Source controlled |
| | | variable bit-rate, |
| | | DTX is always enabled. |
| 7.2 | NB, WB | |
| 8.0 | NB, WB | |
| 9.6 | NB, WB, SWB | |
| 13.2 | NB, WB, SWB | |
| 13.2 (Channel Aware) | WB, SWB | |
| 16.4 | NB, WB, SWB, FB | |
| 24.4 | NB, WB, SWB, FB | |
| 32 | WB, SWB, FB | |
| 48 | WB, SWB, FB | |
| 64 | WB, SWB, FB | |
| 96 | WB, SWB, FB | |
| 128 | WB, SWB, FB | |

The EVS bitrates are the source bitrates; that is after source compression or source coding. The EVS bitrates are in units of kilobits per second (kbps). Each EVS bitrate in Table 1 is mapped to corresponding supported bandwidths, where NB is narrowband, WB is wideband, SWB is super wideband and FB is full band as illustrated in FIG. 2. Each bitrate is unique in its mapping to the supported bandwidth except for bitrate 13.2 kbps which has a channel aware option that does not include NB as its supported bandwidth. In various examples, all the bitrates illustrated in Table 1 support discontinuous transmission (DTX).

Table 2 illustrates examples of different bit rate modes and bandwidths for EVS. The bit rates presented in the table are in units of kilobits per second (kbps). As indicated in Table 2, the 13.2 kbps WB and SWB modes may also include Channel Aware mode which may provide error resiliency.

TABLE 2

| | | | | | | | | | |
|---|---|---|---|---|---|---|---|---|---|
| 5.9 | 7.2 | 8.0 | 9.6 | 13.2⁽¹⁾ | 16.4 | 5.9 | 32.0 | 64.0 | 96.0 |

Super Wideband

Wideband

Narrowband

⁽¹⁾13.2 kbps WB and SWB Mode also include Channel Aware mode which provides superior error resiliency for best effort channel voice services.

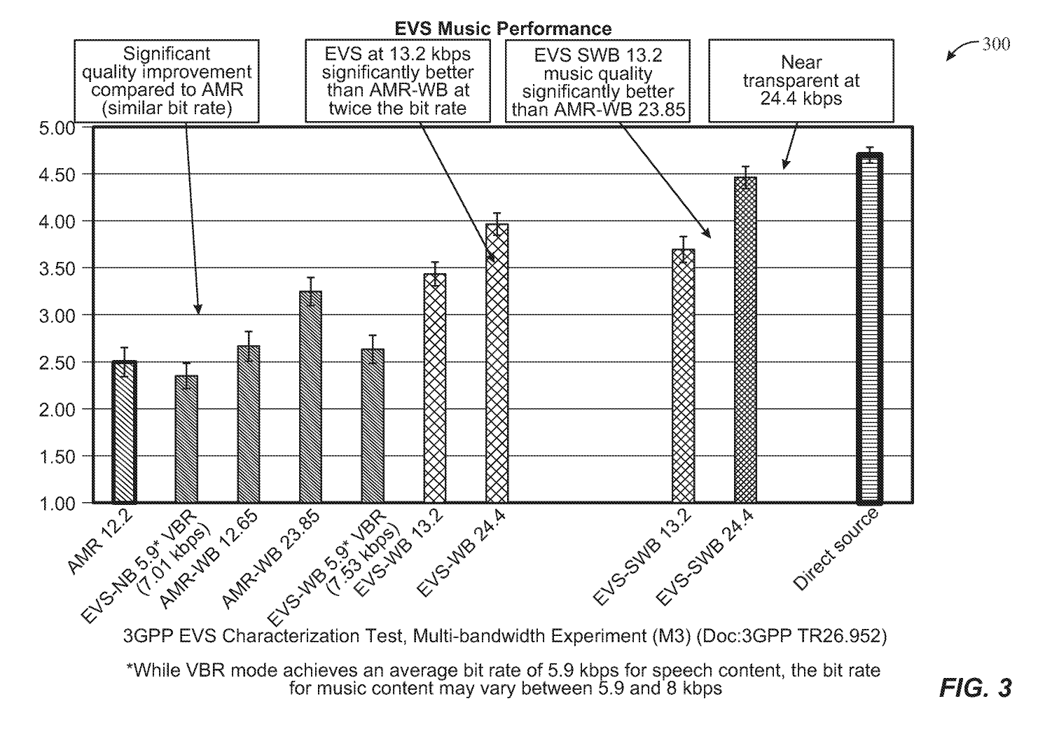

FIG. 3 is a chart 300 illustrating examples of music performances for EVS. In the chart of FIG. 3, different types of codecs are listed on the horizontal axis and plotted in terms of mean opinion source (MOS) on the vertical axis. In the examples of EVS-NB 5.9 with variable bit rate (VBR) and 7.01 kbps transmission rate and EVS-WB 5.9 with variable bit rate (VBR) and 7.53 kbps transmission rate, while the VBR mode achieves an average bit rate of 5.9 kbps for speech content, the bit rate for the music content may vary between 5.9 and 8 kbps. The examples presented in FIG. 3 show that there may be a quality improvement for EVS music performance over AMR at similar bit rates. The examples presented in FIG. 3 show that EVS at 13.2 kbps may have better music performance over AMR-WB at twice the bit rate. The examples presented in FIG. 3 show that EVS at 13.2 kbps may have better music quality over AMR-WB at 23.85 bit rate.

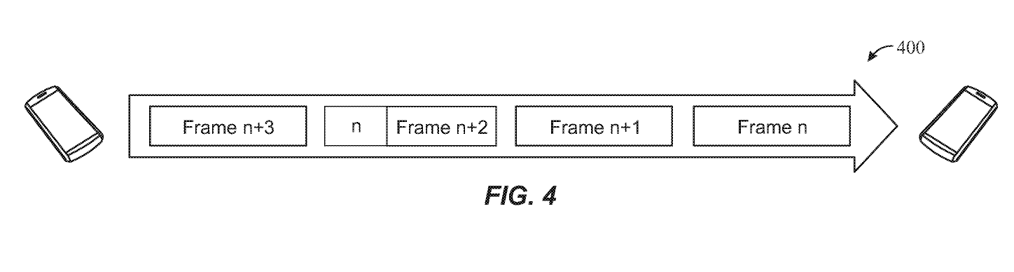

FIG. 4 illustrates an example 400 of an EVS Super Wideband (SWB) channel aware mode (ch-aw mode) at 13.2 kbps. In various examples, the source may control a variable rate in a constant bit rate stream. For example, a partial copy of a previous critical frame may be added to improve error resilience. This is seen by adding “n” to frame n+2.

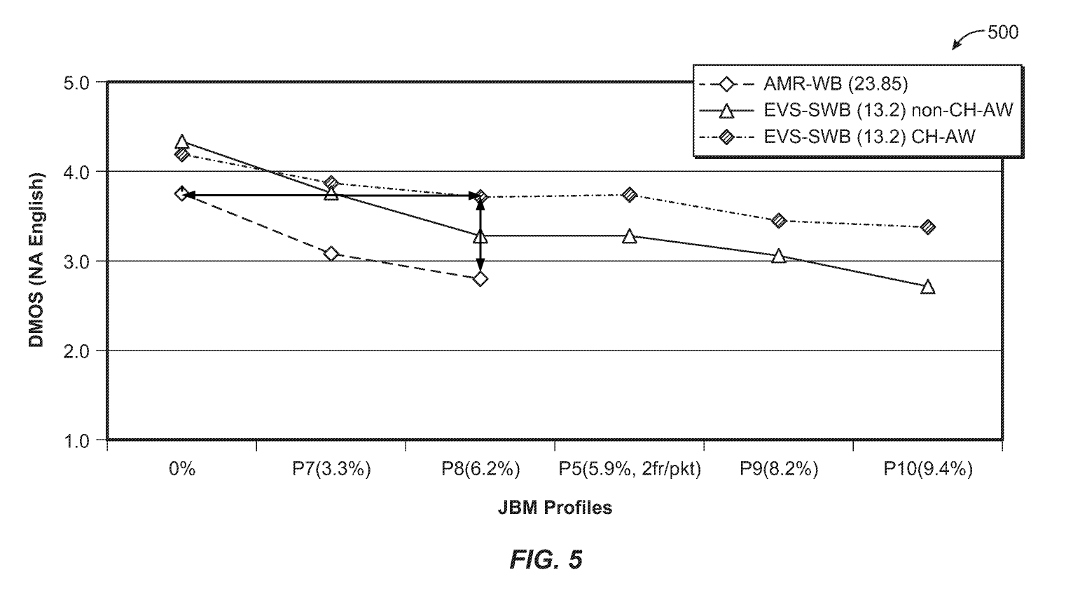

FIG. 5 is a chart 500 illustrating examples of degradation mean opinion score (DMOS) for different error scenarios for three example codecs. The different error scenarios correspond to different frame error rates ranging from 0% to 9.4%. The three example codecs presented in FIG. 5 are: AMR-WB (23.85 kbps); EVS-SWB (13.2 kbps) non-ch-aw; and EVS-SWB (13.2 kbps) ch-aw. The examples illustrated show that clean channel quality may be preserved in ch-aw mode when compared to non-ch-aw mode. For example, EVS SWB ch-aw mode at 6% frame error rate (FER) has the same DMOS as AMR-WB at 23.85 kbps under no loss. For example, EVS SWB ch-aw mode has a degradation mean opinion score (DMOS) improvement of 0.9 over AMR-WB at 23.85 kbps under 6% frame error rate (FER).

Table 3 illustrates examples showing the evolution of EVS bit rates and capacity considerations. In various examples, only minimal network upgrades (if any) may be required as EVS utilizes existing AMR/AMR-WB LTE transport blocks.

TABLE 3

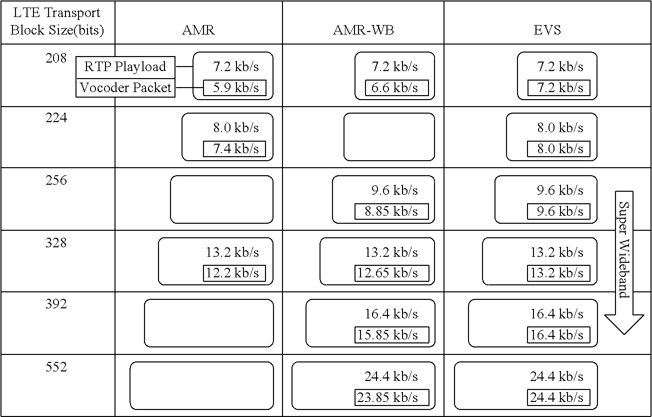

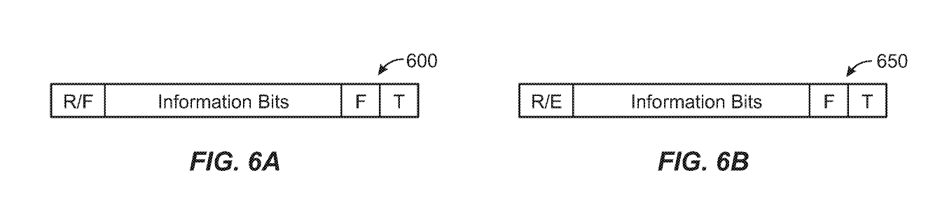

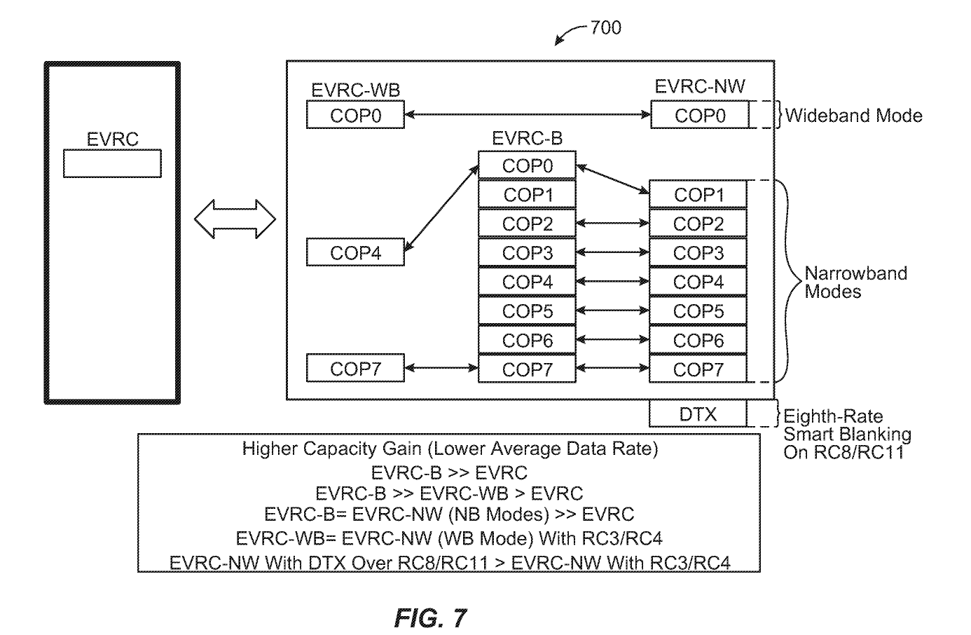

FIG. 6a illustrates an example 600 of a Forward Fundamental Channel (F-FCH) for cdma2000 1× which transports an information payload in the forward direction (i.e., base station to user equipment). As shown in FIG. 6a, R/F is the reserved/flag bits; F is the frame quality indicator (e.g., cyclic redundancy check (CRC)); and T is the encoder tail bits. The information payload may be carried in the field labeled “Information Bits”. In various examples, the F-FCH may contain Radio Configuration (RC) 1 through 9, 11 and 12. All of the listed RCs include frame durations of 20 ms. And, RC 3 through 9 may also include frame durations of 5 ms. For example, a Radio Configuration may include an allocation of bits within a frame, given a frame duration and a data rate.

FIG. 6b illustrates an example 650 of a Reverse Fundamental Channel (R-FCH) for cdma2000 1× which transports an information payload in the reverse direction (i.e., user equipment to base station). As shown in FIG. 6b, R/E is the reserved/erasure indicator bits; F is the frame quality indicator (e.g., cyclic redundancy check (CRC)); and T is the encoder tail bits. The information payload may be carried in the field labeled “Information Bits”. In various examples, the R-FCH may contain Radio Configuration (RC) 1 through 6 and 8. All of the listed RCs include frame durations of 20 ms. And, RC 3 through 6 may also include frame durations of 5 ms. For example, a Radio Configuration may include an allocation of bits within a frame, given a frame duration and a data rate.

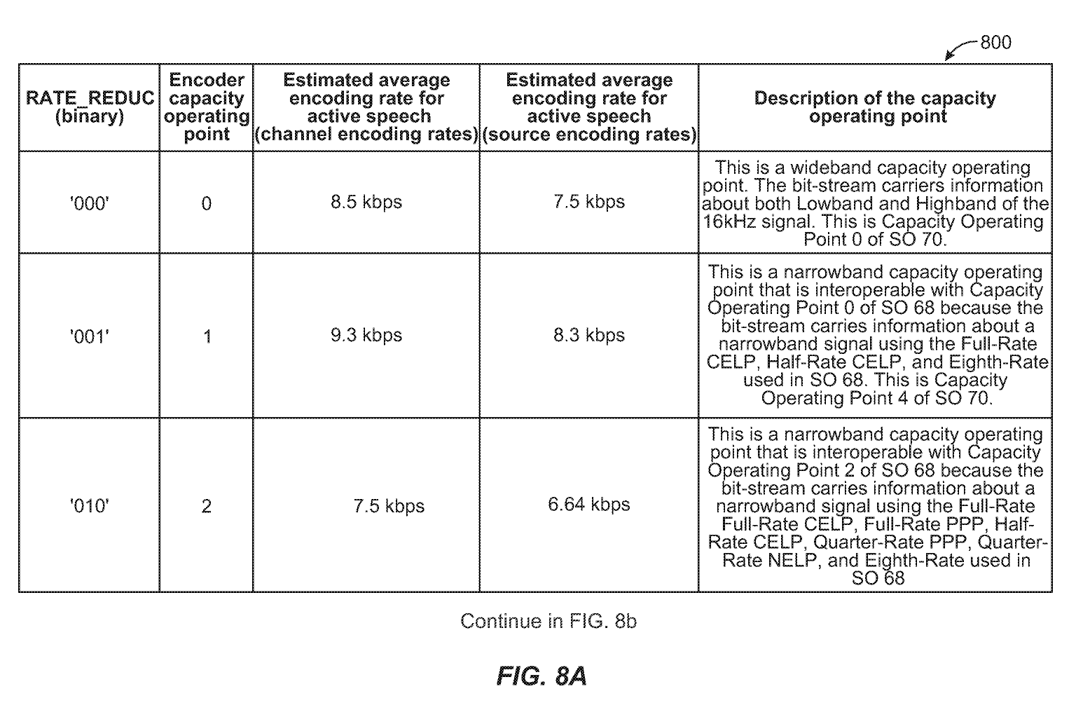

FIG. 7 is a diagram conceptually illustrating an example of Enhanced Variable Rate Codec (EVRC) family of mode structures 700. In various examples, vocoder hard handoffs via service option (SO) negotiation may occur between EVRC and EVRC-WB In various examples, vocoder frame interoperability via service option control message (SOCM) negotiation may be possible between EVRC-WB and EVRC-NW. In various examples, NW represents a combined narrowband (NB) and wideband (WB) codec. Also, COP as used in FIG. 7 stands for capacity operating point.

Table 4 shows the number of bits per frame for each Radio Configuration and date rate for the Forward Fundamental Channel (F-FCH). Table 4 shows the allocation of bits per frame for the F-FCH for each entry of RC and date rate. The allocations include bits per frame for a) reserved/flag, b) information payload, c) frame quality indicator and d) encoder tail which add to the total bits per frame for each entry of RC and data rate. The data rate is in units of bits per second (bps). The terms in parenthesis within the data rate column represent the frame duration. And, for each row entry, the product of data rate (in bps) and the frame duration (converted from milliseconds (ms) to seconds) equals the total bits per frame in that row entry.

TABLE 4

| Radio | | | Number of Bits Frame | | | | |
|---|---|---|---|---|---|---|---|
| Configuration | Data Rate | | | | | Frame Quality | |
| on (RC) | (bps) | | Total | Reserved/Flag | Information | Indicator | |
| 1 | 9600 | (20 ms) | 192 | 0 | 172 | 12 | 8 |
| | 4800 | (20 ms) | 96 | 0 | 80 | 8 | 8 |
| | 2400 | (20 ms) | 48 | 0 | 40 | 0 | 8 |
| | 1200 | (20 ms) | 24 | 0 | 16 | 0 | 8 |
| 2 | 14400 | (20 ms) | 288 | 1 | 267 | 12 | 8 |
| | 7200 | (20 ms) | 144 | 1 | 125 | 10 | 8 |
| | 3600 | (20 ms) | 72 | 1 | 55 | 8 | 8 |
| | 1800 | (20 ms) | 36 | 1 | 21 | 6 | 8 |
| 3, 4, 6, and 7 | 9600 | (5 ms) | 48 | 0 | 24 | 16 | 8 |
| | 9600 | (20 ms) | 192 | 0 | 172 | 12 | 8 |
| | 4800 | (20 ms) | 96 | 0 | 80 | 8 | 8 |
| | 2700 | (20 ms) | 54 | 0 | 40 | 6 | 8 |
| | 1800 | (20 ms) | 30 | 0 | 16 | 6 | 8 |
| 5, 8, and 9 | 9600 | (5 ms) | 48 | 0 | 24 | 16 | 8 |
| | 14400 | (20 ms) | 288 | 1 | 267 | 12 | 8 |
| | 7200 | (20 ms) | 144 | 1 | 125 | 10 | 8 |
| | 3600 | (20 ms) | 72 | 1 | 55 | 8 | 8 |
| | 1800 | (20 ms) | 36 | 1 | 21 | 6 | 8 |
| 11 and 12 | 9600 | (20 ms) | 192 | 0 | 172 | 12 | 8 |
| | 5000 | (20 ms) | 100 | 0 | 80 | 12 | 8 |
| | 3000 | (20 ms) | 60 | 0 | 40 | 12 | 8 |
| | 1800 | (20 ms) | 36 | 0 | 16 | 12 | 8 |

Table 5 shows the number of bits per frame for each Radio Configuration and date rate for the Reverse Fundamental Channel (R-FCH). Table 5 shows the allocation of bits per frame for the R-FCH for each entry of RC and date rate. The allocations include bits per frame for a) reserved/erasure indicator, b) information payload, c) frame quality indicator and d) encoder tail which add to the total bits per frame for each entry of RC and data rate. The data rate is in units of bits per second (bps). The terms in parenthesis within the data rate column represent the frame duration. And, for each row entry, the product of data rate (in bps) and the frame duration (converted from milliseconds (ms) to seconds) equals the total bits per frame in that row entry.

TABLE 5

| Radio | Transmission | | Number of Bits Frame | | | | |
|---|---|---|---|---|---|---|---|
| Configuration | Rate | | | | | Frame Quality | |
| on (RC) | (bps) | | Total | Reserved/Flag | Information | Indicator | Encoder Tail |
| 1 | 9600 | (20 ms) | 192 | 0 | 172 | 12 | 8 |
| | 4800 | (20 ms) | 96 | 0 | 80 | 8 | 8 |
| | 2400 | (20 ms) | 48 | 0 | 40 | 0 | 8 |
| | 1200 | (20 ms) | 24 | 0 | 16 | 0 | 8 |
| 2 | 14400 | (20 ms) | 288 | 1 | 267 | 12 | 8 |
| | 7200 | (20 ms) | 144 | 1 | 125 | 10 | 8 |
| | 3600 | (20 ms) | 72 | 1 | 55 | 8 | 8 |
| | 1800 | (20 ms) | 36 | 1 | 21 | 6 | 8 |
| 3 and 5 | 9600 | (5 ms) | 48 | 0 | 24 | 16 | 8 |
| | 9600 | (20 ms) | 192 | 0 | 172 | 12 | 8 |
| | 4800 | (20 ms) | 96 | 0 | 80 | 8 | 8 |
| | 2700 | (20 ms) | 54 | 0 | 40 | 6 | 8 |
| | 1500 | (20 ms) | 30 | 0 | 16 | 6 | 8 |
| 4 and 6 | 9600 | (5 ms) | 48 | 0 | 24 | 16 | 8 |
| | 14400 | (20 ms) | 288 | 1 | 267 | 12 | 8 |
| | 7200 | (20 ms) | 144 | 1 | 125 | 10 | 8 |
| | 3600 | (20 ms) | 72 | 1 | 55 | 8 | 8 |
| | 1800 | (20 ms) | 36 | 1 | 21 | 6 | 8 |
| 8 | 9600 | (20 ms) | 192 | 0 | 172 | 12 | 8 |
| | 5000 | (20 ms) | 100 | 0 | 80 | 12 | 8 |
| | 3000 | (20 ms) | 60 | 0 | 40 | 12 | 8 |
| | 1800 | (20 ms) | 36 | 0 | 16 | 12 | 8 |

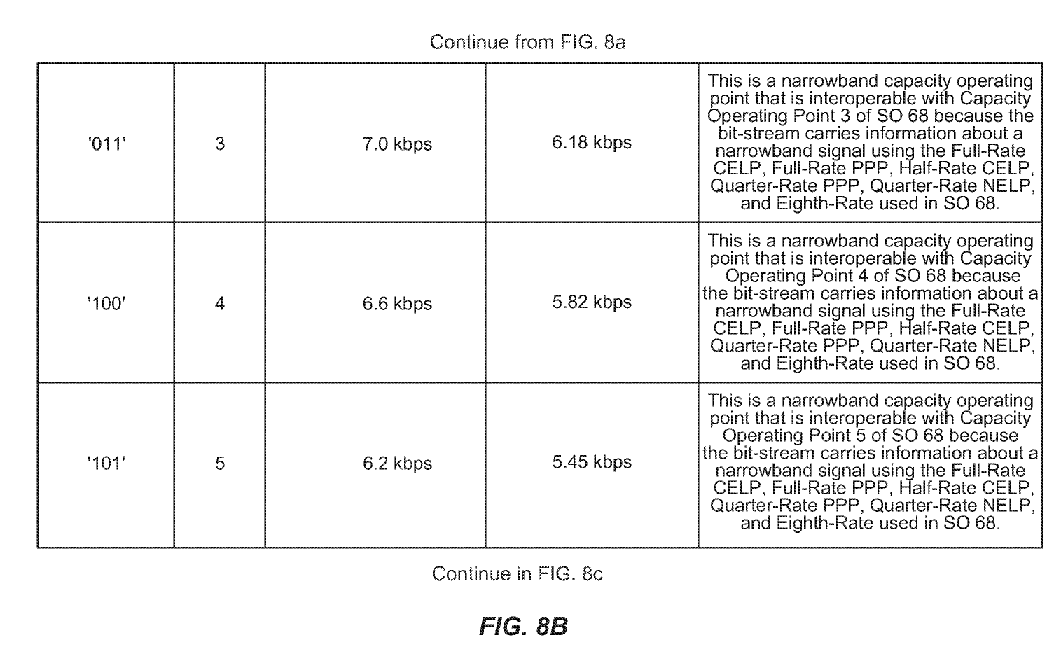

FIGS. 8a, 8b & 8c illustrate an example of a table 800 showing Service Option 73 encoding rate control parameters. In various examples, Service Option 73 may use the family of EVRC codecs, for example, the EVRC-NW codec. The table shows both channel encoding rates and source encoding rates for various encoder operating points.

In various examples, EVS benefits may include enhanced error resilience, better capacity and/or superior quality. There may be improved robustness to data loss, which may be significant. Also, an EVS codec may include designs tested under delay jitter conditions. These characteristics may enhance error resilience. In various examples, EVS wide range bitrates may be as follows: super wideband (SWB) in 9.6-128 kbps range; wideband (WB) in 5.9-128 kbps range and narrowband (NB) in 5.9-24.4 kbps range. In various examples, the SWB mode includes an audio frequency range of 50 Hz to 16 KHz. In various examples, EVS's superior quality is seen in having better quality NB mode and WB mode than AMR/AMR-WB. In various examples, EVS allows entertainment quality for SWB music. Regarding better capacity, the SWB may, for example, be at 13.2 kbps and WB starting at 5.9 kbps.

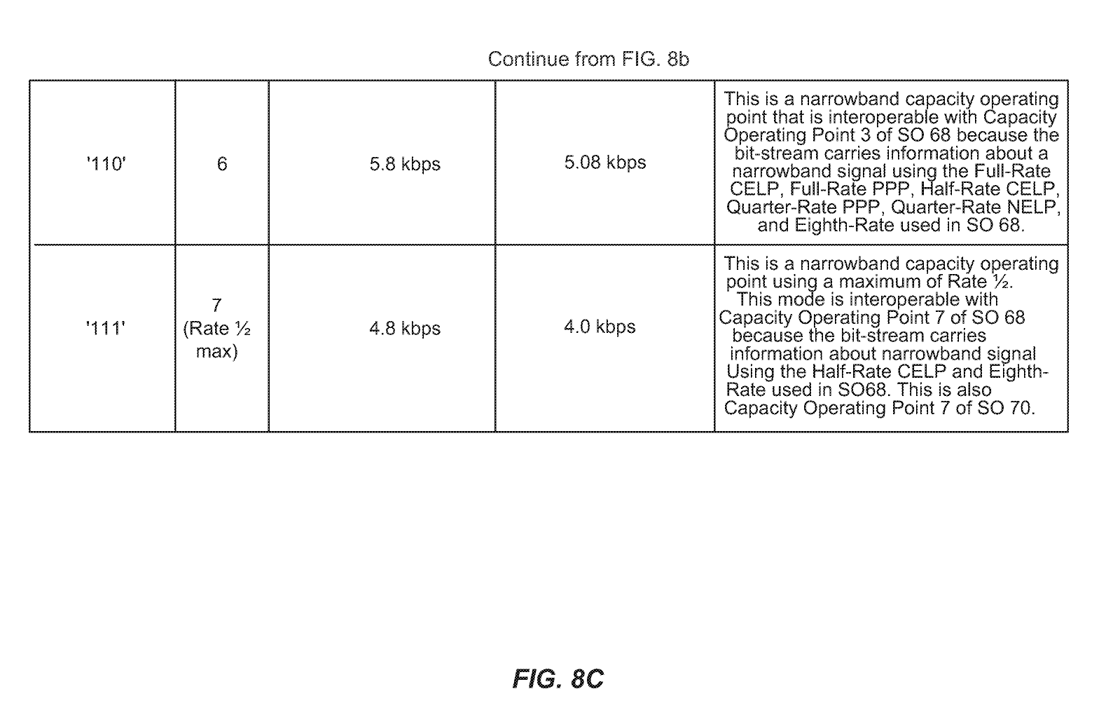

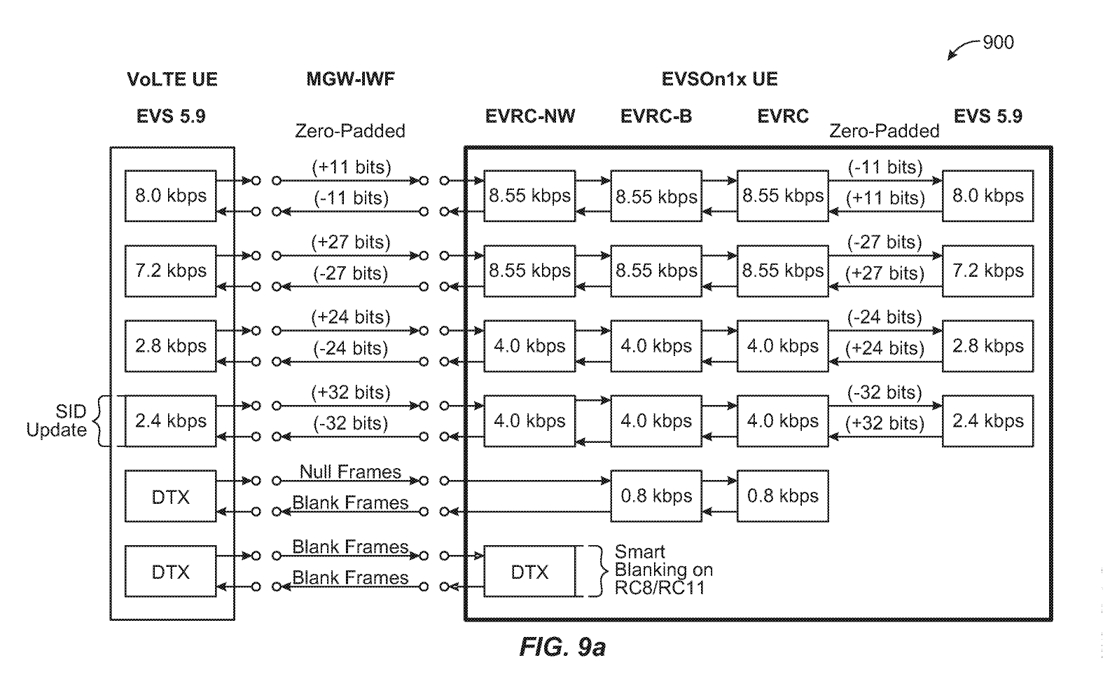

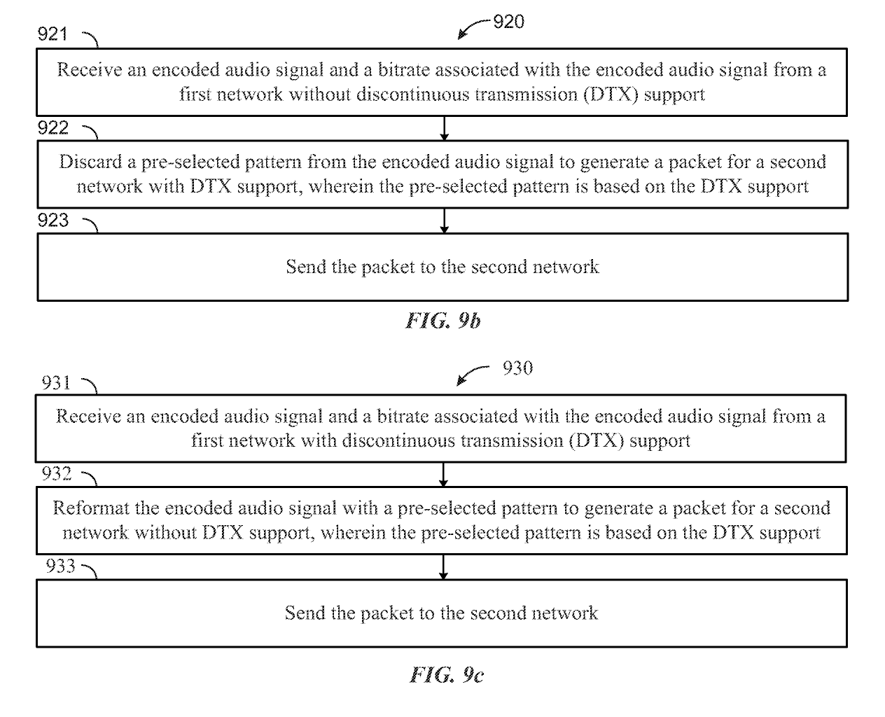

FIG. 9a illustrates an example 900 of EVS 5.9 frames zero padded into existing Enhanced Variable Rate Codec (EVRC) family of codecs frames or packets. In various examples, having the EVS 5.9 frames zero padded into existing EVRC family of codecs frames or packets requires minimal network updates when interworking from one system to another. For example, when interworking from a Long-Term Evolution (LTE) network to a cdma2000 1× network, if discontinuous transmission (DTX) is supported on the LTE network, but not in the cdma2000 1× circuit-switched (CS) network, the Media Gateway-Interworking Function (MGW-IWF) may add null frames to an encoded audio signal (e.g., voice) at the time of interworking from LTE to cdma2000 1× CS. Alternately, the MGW-IWF may discard null frames when interworking from cdma2000 1× CS to LTE. If, however, DTX is supported on both networks (e.g., LTE and cdma2000 1× CS), no action is required by the MGW-IWF. EVS is Enhanced Voice Services. EVSOn1x, as shown in FIG. 9a, is EVS on CDMA2000 1×.

FIG. 9b illustrates a first example 920 of interworking between a first network and a second network. In various aspects, interworking networks may interact by receiving an encoded audio signal and a bitrate associated with the encoded audio signal from a first network without discontinuous transmission (DTX) support as shown in block 921. In block 922, the interaction may include discarding a pre-selected pattern from the encoded audio signal to generate a packet for a second network with DTX support, wherein the pre-selected pattern is based on the DTX support. And, in block 923, the interaction may include sending the packet to the second network. In some examples, the first network is a cdma2000 1× CS network and the second network is a LTE network.

FIG. 9c illustrates a second example 930 of interworking between a first network and a second network. In various aspects, interworking networks may interact by receiving an encoded audio signal and a bitrate associated with the encoded audio signal from a first network with discontinuous transmission (DTX) support as shown in block 931. In block 932, the interaction may include reformatting the encoded audio signal with a pre-selected pattern to generate a packet for a second network without DTX support, wherein the pre-selected pattern is based on the DTX support. And, in block 933, the interaction may include sending the packet to the second network. In some examples, the first network is a LTE network and the second network is a cdma2000 1× CS network.

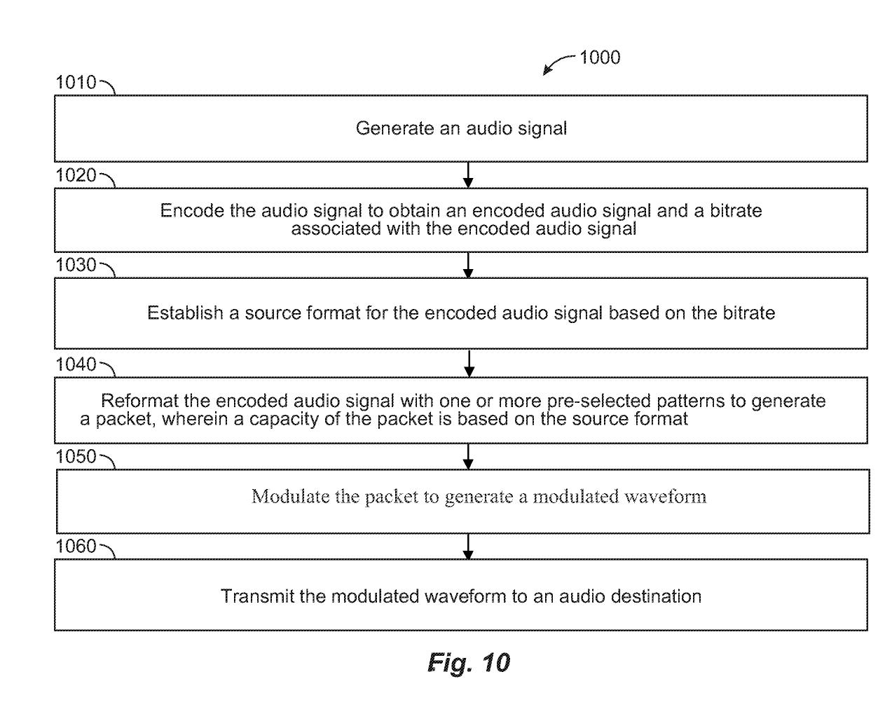

FIG. 10 is a flow chart 1000 illustrating an exemplary method for Enhanced Voice Services (EVS) encoding packet compatibility in a non-native EVS system in accordance with some aspects of the present disclosure.

In block 1010, an audio source generates an audio signal. In various examples, the audio source may include a microphone, an audio player, a transducer or a speech synthesizer, etc. In some examples, the microphone, the audio player, the transducer, or the speech synthesizer are components within a user equipment.

In block 1020, an encoder encodes the audio signal to obtain an encoded audio signal and a bitrate associated with the encoded audio signal. In various examples, the audio signal is supported in one of the following bandwidths (i.e., supported bandwidth): narrowband (NB); wideband (WB), super wideband (SWB) and full band (FB), for example, over an audio frequency range up to 20 kHz (i.e., 0 kHz to 20 kHz). Similarly, the encoded audio signal is supported in one of the following bandwidths (i.e., supported bandwidth): narrowband (NB); wideband (WB), super wideband (SWB) and full band (FB), for example, over an audio frequency range up to 20 kHz (i.e., 0 kHz to 20 kHz). In various examples, the bitrate is an Enhanced Voice Services (EVS) bitrate. The bitrate may be mapped into one of the supported bandwidths.

In various examples, the encoder may be part of a codec which includes the encoder and a decoder. In various examples, the audio signal is a speech signal or a music signal. In various examples, the encoder is a source encoder. In various examples, the encoder is a digital speech encoder. In various examples, the encoder is an EVS encoder which encodes audio signals per standards associated with the Enhanced Voice Services (EVS). The bitrate, for example, may be a source encoding rate. And, a plurality of bitrates may be mapped to one of the supported bandwidths.

In various examples, the encoded audio signal is an Enhanced Voice Services (EVS) packet which may be a formatted group of bits with an associated EVS bitrate per EVS standards. The encoded audio signal may be a channel aware mode, for example, an EVS Super Wideband (SWB) channel aware mode (ch-aw mode) at 13.2 kbps. That is, the encoded audio signal may be one of the following: an Enhanced Voice Services (EVS) Source Controlled Variable Bit Rate (SC-VBR) at 5.9 kbps, an Enhanced Voice Services (EVS) Super Wideband (SWB) channel aware mode (ch-aw mode) at 13.2 kbps or an Enhanced Voice Services (EVS) packet.

In block 1030, a controller establishes a source format for the encoded audio signal based on the bitrate. In various examples, the source format is a radio configuration (RC), for example, for cdma2000 1×. In various examples, the controller may be implemented by a processor or a processing unit. In some aspects, establishing the source format or RC for the encoded audio signal may include establishing a data rate associated with the source format or radio configuration (RC). For example, the radio configuration may be a physical channel configuration based on a channel data rate, including forward error correction (FEC) parameters, modulation parameters and spreading factors.

Various data rates associated with particular source formats or RCs may be found, for example, in Tables 4 and 5 for F-FCH or R-FCH, respectively. For example, the data rate may be a channel encoding rate.

In block 1040, a framer reformats the encoded audio signal with one or more pre-selected patterns to generate a packet, wherein a capacity of the packet is based on the source format (or the radio configuration (RC)). In various examples, a packet is a formatted group of bits which contains an encoded audio signal within the formatted group of bits. That is, the formatted group of bits include the encoded audio signal and may also include other auxiliary bits (e.g., overhead bits that are used for transport of the encoded audio signal, but do not include the encoded audio signal itself).

In block 1050, a modulator modulates the packet to generate a modulated waveform. For example, the modulator takes the formatted group of bits (i.e., the packet) and converts the formatted group of bits sequentially to a modulated waveform according to a modulation rule (which may be predetermined). For example, a modulation rule may convert a zero bit to a first phase state of the modulated waveform and a one bit to a second phase state of the modulated waveform. A phase state is a discrete phase offset of the modulated waveform (e.g., 0 degree or 180 degree).

In block 1060, a transmitter transmits the modulated waveform to an audio destination. In various examples, the audio destination is an audio consumer, such as but not limited to, a speaker, a headphone, a recording device, a digital storage device, etc. In some examples, an antenna is used to transmit the modulated waveform. The antenna may work in conjunction with the transmitter to transmit the modulated waveform.

For example, the pre-selected patterns may be one or more zero-fill bits, or one or more one-fill bits. In other examples, the pre-selected patterns may include patterns of arbitrary groups of bits or the pre-selected patterns may include patterns of an arbitrary group of bits. The packet may include prepended bits e.g., reserved bits, flag bits, erasure bits or a frame quality indicator. In various examples, the frame quality indicator is a group of bits that indicates the integrity of a frame of bits. For example, the frame quality indicator may be a cyclic redundancy check (CRC). The packet may include appended bits e.g., encoder tail bits.

For example, for cdma2000 Rate Set 1 (RS 1) with full rate coding at 8.5 kbps, RC3 (9.6 kbps) for F-FCH and RC3 (9.6 kbps) for R-FCH may be used. Also for example, EVS wideband modes 5.9 kbps, 7.2 kbps, 8.0 kbps and 2.8 kbps may be reformatted with one or more pre-selected patterns to generate a packet with RS land RC3. In various examples, the packet may support discontinuous transmission (DTX). For example, the encoded audio signal may be reformatted with one or more null frames to generate the packet during DTX. For example, a transmitter for transmitting the modulated waveform negotiates with another network entity (e.g., a user equipment) to use the encoded audio signal without DTX.

In various examples, the packet may be compatible with a cdma2000 1× channel. In some examples, the packet may be compatible with any channel per the 3GPP2 standards. For example, the packet may be compatible with a 4G-LTE channel, a 3G-WCDMA channel, a WLAN (e.g., WiFi) channel or a Broadband Fixed Network channel. For example, the packet may be compatible with an Enhanced Variable Rate Codec (EVRC) mode structure.

In various examples when DTX is supported on the 3GPP LTE network, a gateway and/or the MSC may add/remove null/blank frames. Null/blank frames may not be zero-padded. For example, another network element such as a gateway and/or the MSC may add or remove null or blank frames to maintain capability with DTX functionality. Null or blank frames may have values other than zero to avoid additional noise insertion. In addition, the base station may add or remove null or blank frames to maintain capability with DTX functionality.

The capacity of the packet is measured by how many information bits (e.g., not including overhead bits) are available in the packet. In various examples, the framer may be implemented by a processor or a processing unit. It may or may not be the same processor or processing unit that establishes the source format or the radio configuration (RC).

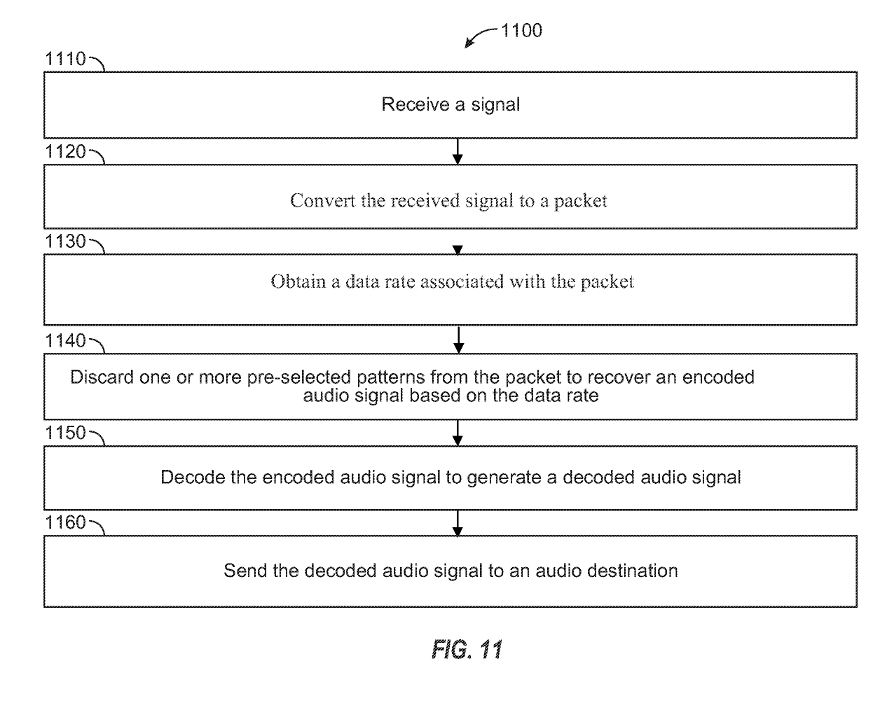

FIG. 11 is a flow chart 1100 illustrating an exemplary method for Enhanced Voice Services (EVS) decoding packet compatibility in a non-native EVS system in accordance with some aspects of the present disclosure. In block 1110, a receiver receives a signal. In various examples, the signal may be received from an audio transmitter.

In block 1120, a demodulator converts the received signal to a packet. In various examples, a packet is a formatted group of bits which contains an encoded audio signal within the formatted group of bits. That is, the formatted group of bits includes the encoded audio signal and may also include other auxiliary bits (e.g., overhead bits that are used for transport of the encoded audio signal, but do not contain information of the encoded audio signal). The demodulator converts the received signal by performing a decision on successive portions of the received signal to determine the formatted group of bits (i.e., to convert the received signal to the packet).

In block 1130, a processor obtains a data rate associated with the packet. The packet may include prepended bits e.g., reserved bits, flag bits, erasure bits or a frame quality indicator. In various examples, the frame quality indicator is a group of bits that indicate the integrity of a frame of bits. For example, the frame quality indicator may be a cyclic redundancy check (CRC). The packet may include appended bits e.g., encoder tail bits.

In various examples, the packet may be a cdma2000 1× channel. In some examples, the packet may be any channel per the 3GPP2 standards. For example, the packet may be a 4G-LTE channel, a 3G-WCDMA channel, a WLAN (e.g., WiFi) channel or a Broadband Fixed Network channel. For example, the packet may be an Enhanced Variable Rate Codec (EVRC) mode structure.

In block 1140, a deframer discards one or more pre-selected patterns from the packet to recover an encoded audio signal based on the data rate. For example, the pre-selected patterns may be one or more zero-fill bits, or one or more one-fill bits. In other examples, the pre-selected patterns may include patterns of arbitrary groups of bits or the pre-selected patterns may include patterns of an arbitrary group of bits. In various examples, the encoded audio signal is an Enhanced Voice Services (EVS) packet. For example, the encoded audio signal may be a channel aware mode, for example, an EVS Super Wideband (SWB) channel aware mode (ch-aw mode) at 13.2 kbps. In some examples, the data rate may be a channel encoding rate.

In various examples, the capacity of the packet is based on a source format or radio configuration (RC) associated with encoded audio signal. For example, the radio configuration may be a physical channel configuration based on a channel data rate, including forward error correction (FEC) parameters, modulation parameters and spreading factors.

The capacity of the packet is measured by how many information bits (e.g., not including overhead bits) are available in the packet. In various examples, a quantity of the one or more pre-selected patterns that is discarded is based on the source format or radio configuration (RC). In various examples, the deframer may be implemented by a processor or a processing unit. In various examples, the deframer is coupled to the receiver and may be part of the receiver or external to the receiver.

In block 1150, a decoder decodes the encoded audio signal to generate a decoded audio signal. In various examples, the decoder may be part of a codec which includes the decoder and an encoder. In various examples, the decoded audio signal is a speech signal or a music signal. In various examples, the decoder is a source decoder. In various examples, the decoder is a digital speech decoder. In various examples, the decoder is an Enhanced Voice Services (EVS) decoder which decodes audio signals per standards associated with the Enhanced Voice Services (EVS). In various examples, the decoded audio signal is an Enhanced Voice Services (EVS) packet.

In various examples, the decoded audio signal is supported in one of the following bandwidths (i.e., supported bandwidth): narrowband (NB); wideband (WB), super wideband (SWB) and full band (FB), for example, over an audio frequency range up to 20 kHz (i.e., 0 kHz to 20 kHz). Similarly, the encoded audio signal is supported in one of the following bandwidths (i.e., supported bandwidth): narrowband (NB); wideband (WB), super wideband (SWB) and full band (FB), for example, over an audio frequency range up to 20 kHz (i.e., 0 kHz to 20 kHz).

In various examples, the bitrate is an Enhanced Voice Services (EVS) bitrate. The bitrate may be mapped into one of the supported bandwidths. The bitrate, for example, may be a source encoding rate. And, a plurality of bitrates may be mapped to one of the supported bandwidths.

In block 1160, the decoder sends the decoded audio signal to an audio destination. In various examples, the audio destination is an audio consumer, such as but not limited to, a speaker, a headphone, a recording device, a digital storage device, a transducer, etc.

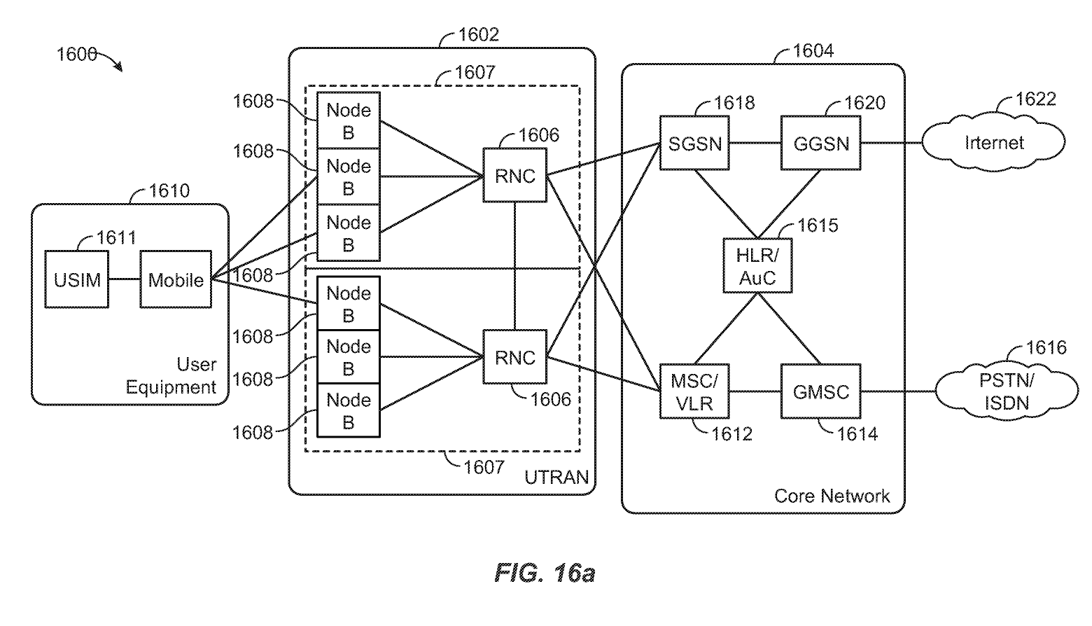

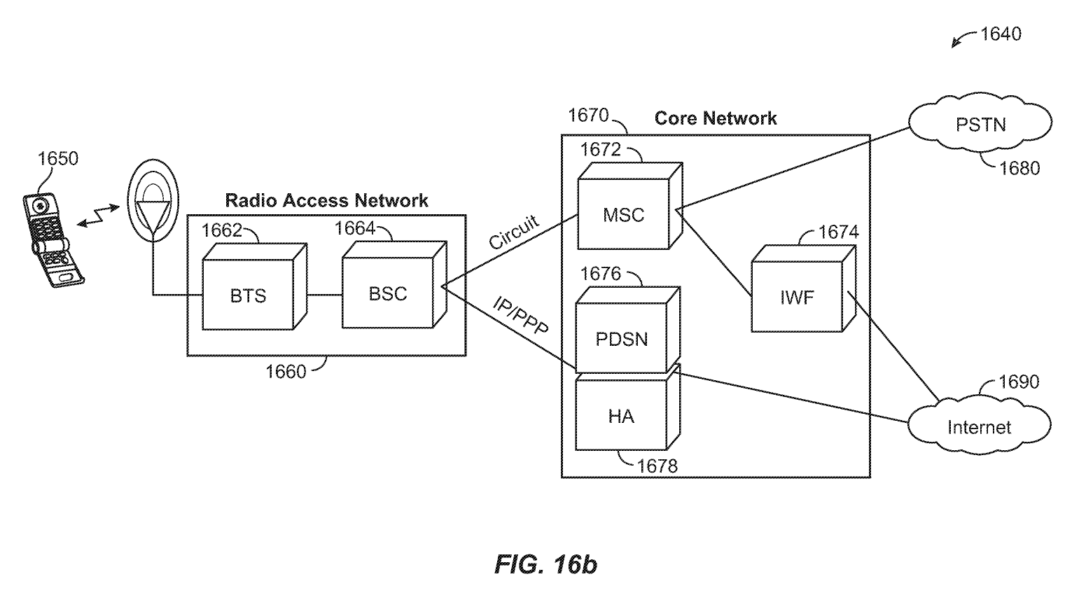

In the example telecommunications system based on 3GPP2 illustrated in FIG. 16b, one or more the following interfaces may be modified. For example, a service option for EVS may be added in the interface between the UE 1650 and the BTS 1662. For example, the interface between BSC 1664 and MSC 1672 (a.k.a. A2 interface) may be updated to support EVS. In various examples, the A2 interface may carry 64/56 kbps Pulse Code Modulation (PCM) information (e.g., circuit oriented voice) or 64 kbps Unrestricted Digital Information (UDI) for Integrated Services Digital Network (ISDN) between a switch component of the MSC 1672 and a Selection Distribution Unit (SDU) of the BSC 1664.

For example the interface between the BSC 1664 and the PDSN 1676 (a.k.a. A2p interface) may be updated to support EVS. In various examples, the interface between the BSC 1664 and a Media Gateway, wherein the Media Gateway may be within the PDSN 1676 or coupled to the PDSN 1676, may be updated to support EVS. In various examples, the A2p interface may provide a path for packet-based user traffic sessions. In various examples, the A2p interface may carry voice information via Internet Protocol (IP) packets between the BSC 1664 and the PDSN 1676 (or between the BSC 1664 and the Media Gateway). In various examples, lawful intercept procedures are made compatible with EVS.

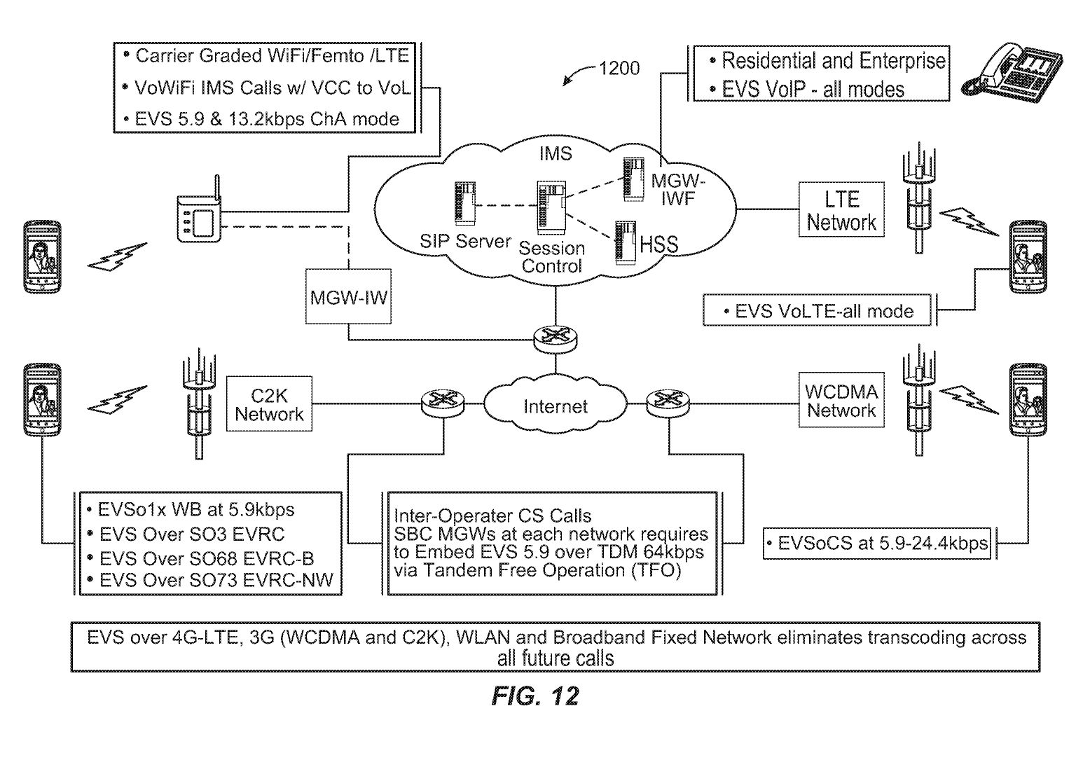

FIG. 12 is a diagram conceptually illustrating an example of a heterogeneous network architecture 1200 with various wireless communication networks. Examples of the various wireless communication networks may include EVS over 4G-LTE, 3G (WCDMA and cdma2000), WLAN (e.g., WiFi) and Broadband Fixed Network. In various examples, the use of these various wireless communication networks in accordance with the present disclosure may eliminate transcoding across inter-network calls.

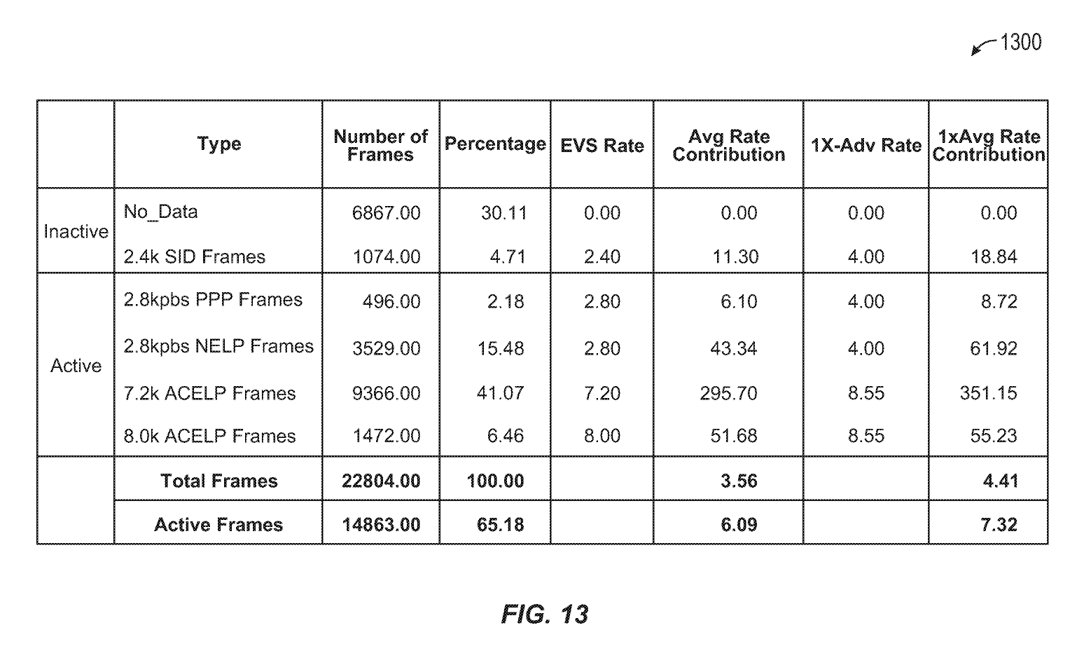

FIG. 13 is a chart 1300 illustrating an example comparison of average rate contributions for both EVS and a cdma2000 1× advanced rate vocoder. The comparison uses a mix of traffic which includes no data, silence insertion descriptor (SID) frames, point-to-point protocol (PPP) frames, noise excitation linear prediction (NELP) frames, and algebraic code excited linear prediction (ACELP) frames.

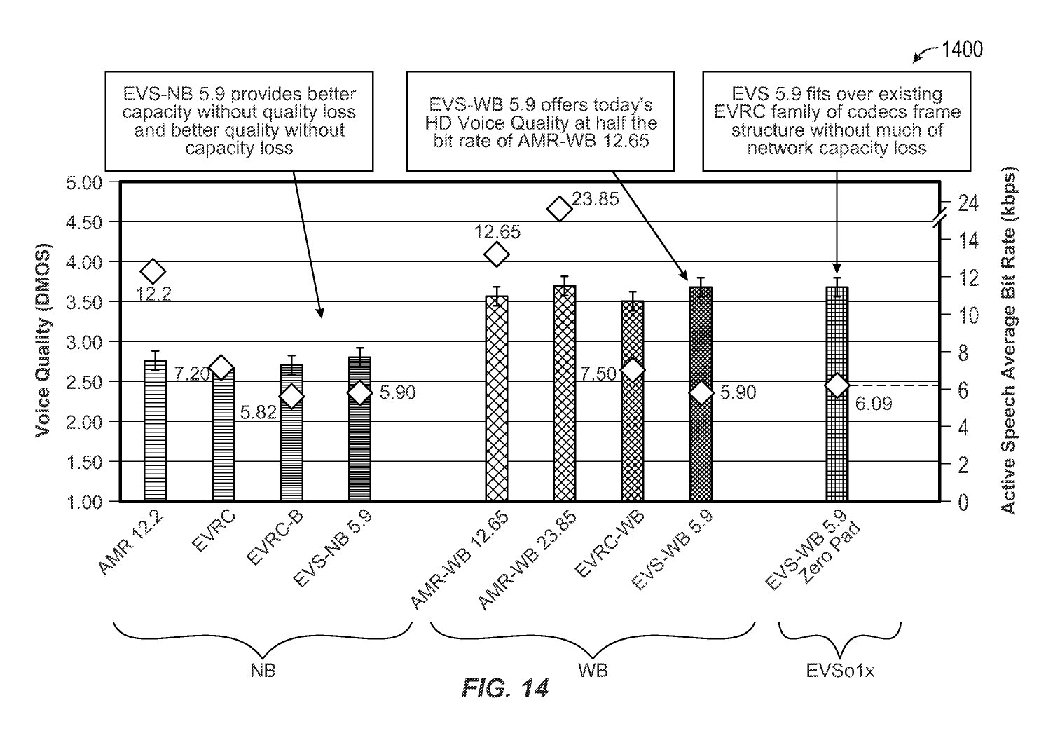

FIG. 14 is a chart 1400 illustrating an example of EVS-WB 5.9 speech quality compared to other vocoders. As presented in the chart, NB stands for narrowband and WB stands for wideband. Different types of codecs (e.g., AMR, EVRC etc.) on the horizontal axis are graphed on the vertical axis in terms of voice quality and active speech average bit rate. As shown in FIG. 14, the voice quality is presented in degradation mean opinion score (DMOS) and the active speech average bit rate is presented in kilobits per second (kbps). Typically, a higher value of DMOS indicates a better subjective voice quality with a scale from 1.0 to 5.0. In the examples presented in the chart of FIG. 14, EVS-NB 5.9 may provide better capacity (i.e., lower average bit rate) without quality loss and better quality (i.e. higher DMOS) without capacity loss. In the examples presented in the chart of FIG. 14, EVS-WB 5.9 may offer high definition (HD) voice quality at half the bit rate of AMR-WB 12.65. In the examples presented in the chart of FIG. 14, EVS 5.9 may fit over existing EVRC family of codecs frame structure with minimal network capacity loss.

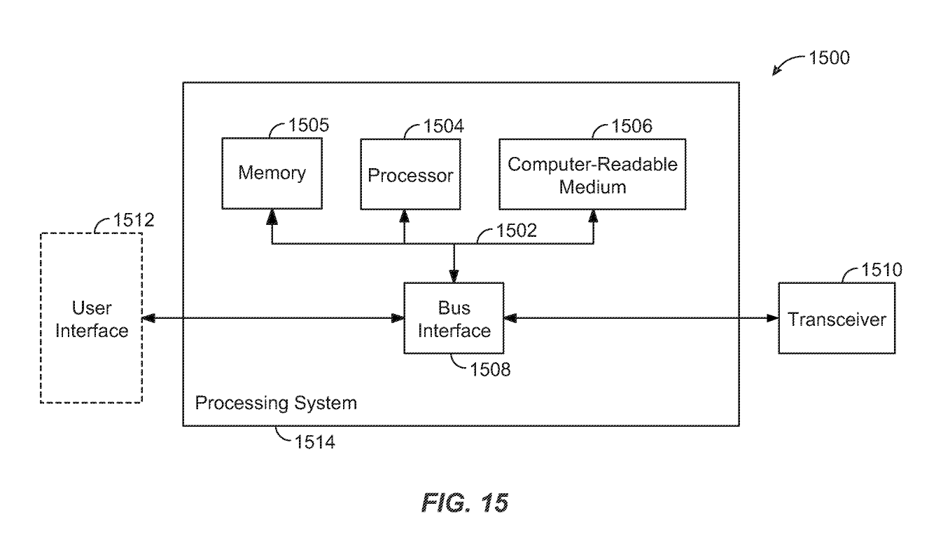

FIG. 15 is a block diagram illustrating an example of a hardware implementation for an apparatus 1500 employing a processing system 1514. In this example, the processing system 1514 may be implemented with a bus architecture, represented generally by the bus 1502. The bus 1502 may include any number of interconnecting buses and bridges depending on the specific application of the processing system 1514 and the overall design constraints. The bus 1502 links together various circuits including one or more processors, represented generally by the processor 1504, memory, represented generally by the memory 1505, and computer-readable media, represented generally by the computer-readable medium 1506. The bus 1502 may also link various other circuits such as timing sources, peripherals, voltage regulators, and power management circuits, which are well known in the art, and therefore, will not be described any further. A bus interface 1508 provides an interface between the bus 1502 and a transceiver 1510. The transceiver 1510 provides a means for communicating with various other apparatus over a transmission medium. Depending upon the nature of the apparatus, a user interface 1512 (e.g., keypad, display, speaker, microphone, joystick) may also be provided.

The processor 1504 is responsible for managing the bus 1502 and general processing, including the execution of software stored on the computer-readable medium 1506. The software, when executed by the processor 1504, causes the processing system 1514 to perform the various functions described infra for any particular apparatus. The computer-readable medium 1506 may also be used for storing data that is manipulated by the processor 1504 when executing software.

The various concepts presented throughout this disclosure may be implemented across a broad variety of telecommunication systems, network architectures, and communication standards. FIG. 16a is a block diagram conceptually illustrating an example of a telecommunications system based on 3GPP. By way of example and without limitation, the aspects of the present disclosure illustrated in FIG. 16a are presented with reference to a UMTS system 1600 employing a W-CDMA air interface. A UMTS network includes three interacting domains: a Core Network (CN) 1604, a UMTS Terrestrial Radio Access Network (UTRAN) 1602, and User Equipment (UE) 1610. In this example, the UTRAN 1602 provides various wireless services including telephony, video, data, messaging, broadcasts, and/or other services. The UTRAN 1602 may include a plurality of Radio Network Subsystems (RNSs) such as an RNS 1607, each controlled by a respective Radio Network Controller (RNC) such as an RNC 1606. Here, the UTRAN 1602 may include any number of RNCs 1606 and RNSs 1607 in addition to the RNCs 1606 and RNSs 1607 illustrated herein. The RNC 1606 is an apparatus responsible for, among other things, assigning, reconfiguring and releasing radio resources within the RNS 1607. The RNC 1606 may be interconnected to other RNCs (not shown) in the UTRAN 1602 through various types of interfaces such as a direct physical connection, a virtual network, or the like, using any suitable transport network.

Communication between a UE 1610 and a Node B 1608 may be considered as including a physical (PHY) layer and a medium access control (MAC) layer. Further, communication between a UE 1610 and an RNC 1606 by way of a respective Node B 1608 may be considered as including a radio resource control (RRC) layer. In the instant specification, the PHY layer may be considered layer 1; the MAC layer may be considered layer 2; and the RRC layer may be considered layer 3.

The geographic region covered by the RNS 1607 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 1608 are shown in each RNS 1607; however, the RNSs 1607 may include any number of wireless Node Bs. The Node Bs 1608 provide wireless access points to a CN 1604 for any number of mobile apparatuses. In a UMTS system, the UE 1610 may further include a universal subscriber identity module (USIM) 1611, which contains a user's subscription information to a network. For illustrative purposes, one UE 1610 is shown in communication with a number of the Node Bs 1608. The DL, also called the forward link, refers to the communication link from a Node B 1608 to a UE 1610, and the UL, also called the reverse link, refers to the communication link from a UE 1610 to a Node B 1608.

The CN 1604 interfaces with one or more access networks, such as the UTRAN 1602. As shown, the CN 1604 is a GSM core network. However, as those skilled in the art will recognize, the various concepts presented throughout this disclosure may be implemented in a RAN, or other suitable access network, to provide UEs with access to types of CNs other than GSM networks.

The CN 1604 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 1604 supports circuit-switched services with a MSC 1612 and a GMSC 1614. In some applications, the GMSC 1614 may be referred to as a media gateway (MGW). One or more RNCs, such as the RNC 1606, may be connected to the MSC 1612. The MSC 1612 is an apparatus that controls call setup, call routing, and UE mobility functions. The MSC 1612 also includes a VLR that contains subscriber-related information for the duration that a UE is in the coverage area of the MSC 1612. The GMSC 1614 provides a gateway through the MSC 1612 for the UE to access a circuit-switched network 1616. The GMSC 1614 includes a home location register (HLR) 1615 containing subscriber data, such as the data reflecting the details of the services to which a particular user has subscribed. The HLR is also associated with an authentication center (AuC) that contains subscriber-specific authentication data. When a call is received for a particular UE, the GMSC 1614 queries the HLR 1615 to determine the UE's location and forwards the call to the particular MSC serving that location.

The CN 1604 also supports packet-data services with a serving GPRS support node (SGSN) 1618 and a gateway GPRS support node (GGSN) 1620. GPRS, which stands for General Packet Radio Service, is designed to provide packet-data services at speeds higher than those available with standard circuit-switched data services. The GGSN 1620 provides a connection for the UTRAN 1602 to a packet-based network 1622. The packet-based network 1622 may be the Internet, a private data network, or some other suitable packet-based network. The primary function of the GGSN 1620 is to provide the UEs 1610 with packet-based network connectivity. Data may be transferred between the 1620 and the UEs 1610 through the SGSN 1618, which performs primarily the same functions in the packet-based domain as the MSC 1612 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 1608 and a UE 1610. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

FIG. 16b is a block diagram 1640 conceptually illustrating an example of a telecommunications system based on 3GPP2 employing a cdma2000 interface. A 3GPP2 network may include three interacting domains: a User Equipment (UE) 1650 (which may also be called a Mobile Station (MS)), a Radio Access Network (RAN) 1660, and a Core Network (CN) 1670. In various examples, the RAN 1660 provides various wireless services including telephony, video, data, messaging, broadcasts, and/or other services. The RAN 1660 may include a plurality of Base Transceiver Stations (BTSs) 1662, each controlled by a respective Base Station Controller (BSC) 1664. The Core Network (CN) 1670 interfaces with one or more access networks, such as the RAN 1660. The CN 1670 may include a circuit-switched (CS) domain and a packet-switched (PS) domain. Some of the circuit-switched elements are a Mobile Switching Center (MSC) 1672 to connect to a Public Switched Telephony Network (PSTN) 1680 and an Inter-Working Function (IWF) 1674 to connect to a network such as the Internet 1690. Packet-switched elements may include a Packet Data Serving Node (PDSN) 1676 and a Home Agent (HA) 1678 to connect to a network such as the Internet 1690. In addition, an Authentication, Authorization, and Accounting (AAA) function (not shown) may be included in the Core Network (CN) 1670 to perform various security and administrative functions.

Examples of a UE may include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The UE is commonly referred to as a mobile apparatus, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

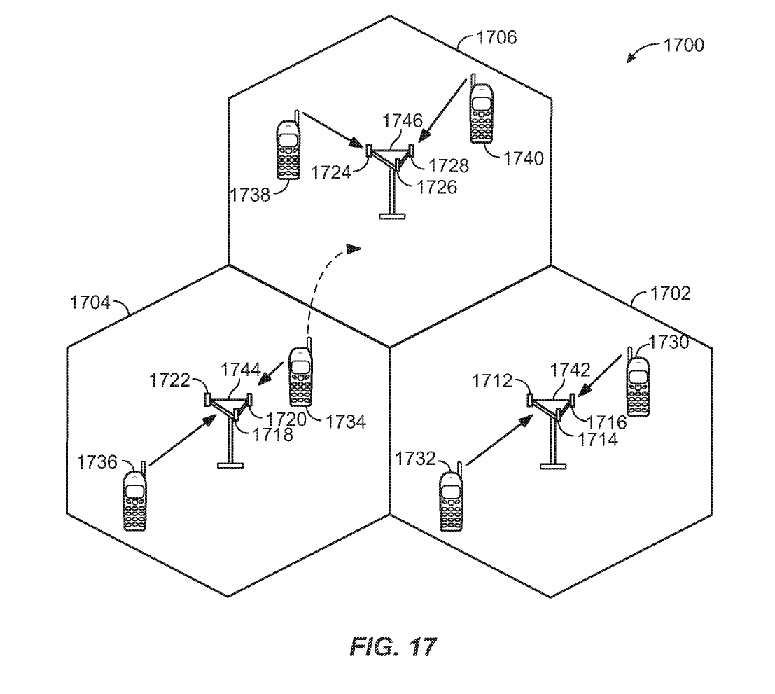

FIG. 17 is a conceptual diagram illustrating an example of an access network. Referring to FIG. 17, an access network 1700 in a UTRAN or RAN architecture is illustrated. The multiple access wireless communication system includes multiple cellular regions (cells), including cells 1702, 1704, and 1706, each of which may include one or more sectors. The multiple sectors can be formed by groups of antennas with each antenna responsible for communication with UEs in a portion of the cell. For example, in cell 1702, antenna groups 1712, 1714, and 1716 may each correspond to a different sector. In cell 1704, antenna groups 1718, 1720, and 1722 each correspond to a different sector. In cell 1706, antenna groups 1724, 1726, and 1728 each correspond to a different sector. The cells 1702, 1704 and 1706 may include several wireless communication devices, e.g., User Equipment or UEs, which may be in communication with one or more sectors of each cell 1702, 1704 or 1706. For example, UEs 1730 and 1732 may be in communication with base station 1742, UEs 1734 and 1736 may be in communication with base station 1744, and UEs 1738 and 1740 can be in communication with base station 1746. References to a base station made herein may include the node B 1608 of FIG. 16a and/or the BTS 1662 of FIG. 16b.

Here, each base station 1742, 1744, 1746 is configured to provide an access point to a core network (see FIGS. 16a, 16b) for all the UEs 1730, 1732, 1734, 1736, 1738, 1740 in the respective cells 1702, 1704, and 1706.

As the UE 1734 moves from the illustrated location in cell 1704 into cell 1706, a serving cell change (SCC) or handover may occur in which communication with the UE 1734 transitions from the cell 1704, which may be referred to as the source cell, to cell 1706, which may be referred to as the target cell. Management of the handover procedure may take place at the UE 1734, at the base stations corresponding to the respective cells, at a radio network controller (RNC) 1606 or Base Station Controller (BSC) 1664 (see FIGS. 16a, 16b), or at another suitable node in the wireless network. For example, during a call with the source cell 1704, or at any other time, the UE 1734 may monitor various parameters of the source cell 1704 as well as various parameters of neighboring cells such as cells 1706 and 1702. Further, depending on the quality of these parameters, the UE 1734 may maintain communication with one or more of the neighboring cells. During this time, the UE 1734 may maintain an Active Set, that is, a list of cells that the UE 1734 is simultaneously connected to (i.e., the UTRA cells that are currently assigning a downlink dedicated physical channel DPCH or fractional downlink dedicated physical channel F-DPCH to the UE 1734 may constitute the Active Set).

The modulation and multiple access scheme employed by the access network 1700 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the cdma2000 family of standards and employs CDMA to provide broadband Internet access to user equipment (e.g., mobile stations). The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, Long-Term Evolution (LTE), LTE Advanced, and GSM are described in documents from the 3GPP organization. cdma2000 and UMB are described in documents from the 3GPP2 organization. The actual wireless communication standard and the multiple access technology employed will depend on the specific application and the overall design constraints imposed on the system.

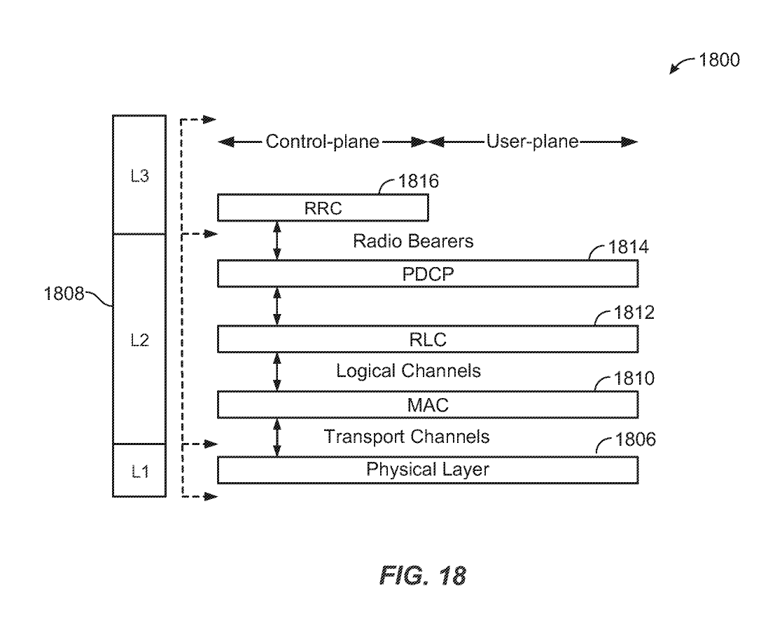

The radio protocol architecture may take on various forms depending on the particular application. FIG. 18 is a conceptual diagram illustrating an example of the radio protocol architecture 1800 for the user and control planes. Turning to FIG. 18, the radio protocol architecture for the UE and the base station is shown with three layers: Layer 1, Layer 2, and Layer 3. Layer 1 is the lowest lower and implements various physical layer signal processing functions. Layer 1 will be referred to herein as the physical layer 1806. Layer 2 (L2 layer) 1808 is above the physical layer 1806 and is responsible for the link between the UE and base station over the physical layer 1806.

In the user plane, the L2 layer 1808 includes a media access control (MAC) sublayer 1810, a radio link control (RLC) sublayer 1812, and a packet data convergence protocol (PDCP) 1814 sublayer, which are terminated at the base station on the network side. Although not shown, the UE may have several upper layers above the L2 layer 1808 including a network layer (e.g., IP layer) that is terminated at a PDN gateway on the network side, and an application layer that is terminated at the other end of the connection (e.g., far end UE, server, etc.).

The PDCP sublayer 1814 provides multiplexing between different radio bearers and logical channels. The PDCP sublayer 1814 also provides header compression for upper layer data to reduce radio transmission overhead, security by ciphering the data, and handover support for UEs between base stations. The RLC sublayer 1812 provides segmentation and reassembly of upper layer data, retransmission of lost data, and reordering of data to compensate for out-of-order reception due to hybrid automatic repeat request (HARQ). The MAC sublayer 1810 provides multiplexing between logical and transport channels. The MAC sublayer 1810 is also responsible for allocating the various radio resources (e.g., resource blocks) in one cell among the UEs. The MAC sublayer 1810 is also responsible for HARQ operations.

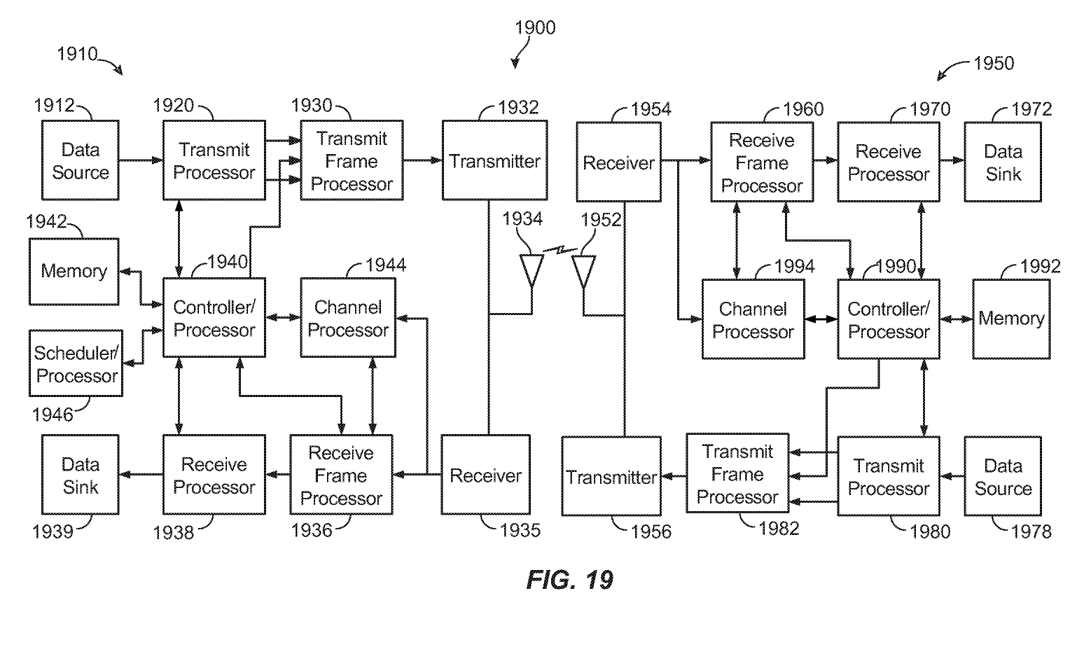

FIG. 19 is a block diagram 1900 of a base station (BS) 1910 in communication with a UE 1950, where the base station 1910 may be the Node B 1608 or the BTS 1662 in FIG. 16a, 16b respectively, and the UE 1950 may be the UE 1610, 1650 in FIGS. 16a, 16b. In the downlink communication, a transmit processor 1920 may receive data from a data source 1912 and control signals from a controller/processor 1940. The transmit processor 1920 provides various signal processing functions for the data and control signals, as well as reference signals (e.g., pilot signals). For example, the transmit processor 1920 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1944 may be used by a controller/processor 1940 to determine the coding, modulation, spreading, and/or scrambling schemes for the transmit processor 1920. These channel estimates may be derived from a reference signal transmitted by the UE 1950 or from feedback from the UE 1950. The symbols generated by the transmit processor 1920 are provided to a transmit frame processor 1930 to create a frame structure. The transmit frame processor 1930 creates this frame structure by multiplexing the symbols with information from the controller/processor 1940, resulting in a series of frames. The frames are then provided to a transmitter 1932, which provides various signal conditioning functions including amplifying, filtering, and modulating the frames onto a carrier for downlink transmission over the wireless medium through antenna 1934. The antenna 1934 may include one or more antennas, for example, including beam steering bidirectional adaptive antenna arrays or other similar beam technologies.

At the UE 1950, a receiver 1954 receives the downlink transmission through an antenna 1952 and processes the transmission to recover the information modulated onto the carrier. The information recovered by the receiver 1954 is provided to a receive frame processor 1960, which parses each frame, and provides information from the frames to a channel processor 1994 and the data, control, and reference signals to a receive processor 1970. The receive processor 1970 then performs the inverse of the processing performed by the transmit processor 1920 in the base station 1910. More specifically, the receive processor 1970 descrambles and despreads the symbols, and then determines the most likely signal constellation points transmitted by the base station 1910 based on the modulation scheme. These soft decisions may be based on channel estimates computed by the channel processor 1994. The soft decisions are then decoded and deinterleaved to recover the data, control, and reference signals. The CRC codes are then checked to determine whether the frames were successfully decoded. The data carried by the successfully decoded frames will then be provided to a data sink 1972, which represents applications running in the UE 1950 and/or various user interfaces (e.g., display). Control signals carried by successfully decoded frames will be provided to a controller/processor 1990. When frames are unsuccessfully decoded by the receiver processor 1970, the controller/processor 1990 may also use an acknowledgement (ACK) and/or negative acknowledgement (NACK) protocol to support retransmission requests for those frames.

In the uplink, data from a data source 1978 and control signals from the controller/processor 1990 are provided to a transmit processor 1980. The data source 1978 may represent applications running in the UE 1950 and various user interfaces (e.g., keyboard). Similar to the functionality described in connection with the downlink transmission by the base station 1910, the transmit processor 1980 provides various signal processing functions including CRC codes, coding and interleaving to facilitate FEC, mapping to signal constellations, spreading with OVSFs, and scrambling to produce a series of symbols. Channel estimates, derived by the channel processor 1994 from a reference signal transmitted by the base station 1910 or from feedback contained in the midamble transmitted by the base station 1910, may be used to select the appropriate coding, modulation, spreading, and/or scrambling schemes. The symbols produced by the transmit processor 1980 will be provided to a transmit frame processor 1982 to create a frame structure. The transmit frame processor 1982 creates this frame structure by multiplexing the symbols with information from the controller/processor 1990, resulting in a series of frames. The frames are then provided to a transmitter 1956, which provides various signal conditioning functions including amplification, filtering, and modulating the frames onto a carrier for uplink transmission over the wireless medium through the antenna 1952.

The uplink transmission is processed at the base station 1910 in a manner similar to that described in connection with the receiver function at the UE 1950. A receiver 1935 receives the uplink transmission through the antenna 1934 and processes the transmission to recover the information modulated onto the carrier. The information recovered by the receiver 1935 is provided to a receive frame processor 1936, which parses each frame, and provides information from the frames to the channel processor 1944 and the data, control, and reference signals to a receive processor 1938. The receive processor 1938 performs the inverse of the processing performed by the transmit processor 1980 in the UE 1950. The data and control signals carried by the successfully decoded frames may then be provided to a data sink 1939 and the controller/processor 1940, respectively. If some of the frames were unsuccessfully decoded by the receive processor, the controller/processor 1940 may also use an acknowledgement (ACK) and/or negative acknowledgement (NACK) protocol to support retransmission requests for those frames.

The controller/processors 1940 and 1990 may be used to direct the operation at the base station 1910 and the UE 1950, respectively. For example, the controller/processors 1940 and 1990 may provide various functions including timing, peripheral interfaces, voltage regulation, power management, and other control functions. The computer readable media of memories 1942 and 1992 may store data and software for the base station 1910 and the UE 1950, respectively. A scheduler/processor 1946 at the base station 1910 may be used to allocate resources to the UEs and schedule downlink and/or uplink transmissions for the UEs.

In various examples, wireless networks with EVS coverage may be handed over to a wireless network without EVS coverage, i.e., a non-native EVS system. For example, a UE within a LTE coverage may be handed over to another coverage, e.g., 3GPP2 coverage, without EVS. A transcoder may be used to enable compatibility for EVS coverage with possible increase in delay and decrease in audio quality due to the need for transcoding between different formats.

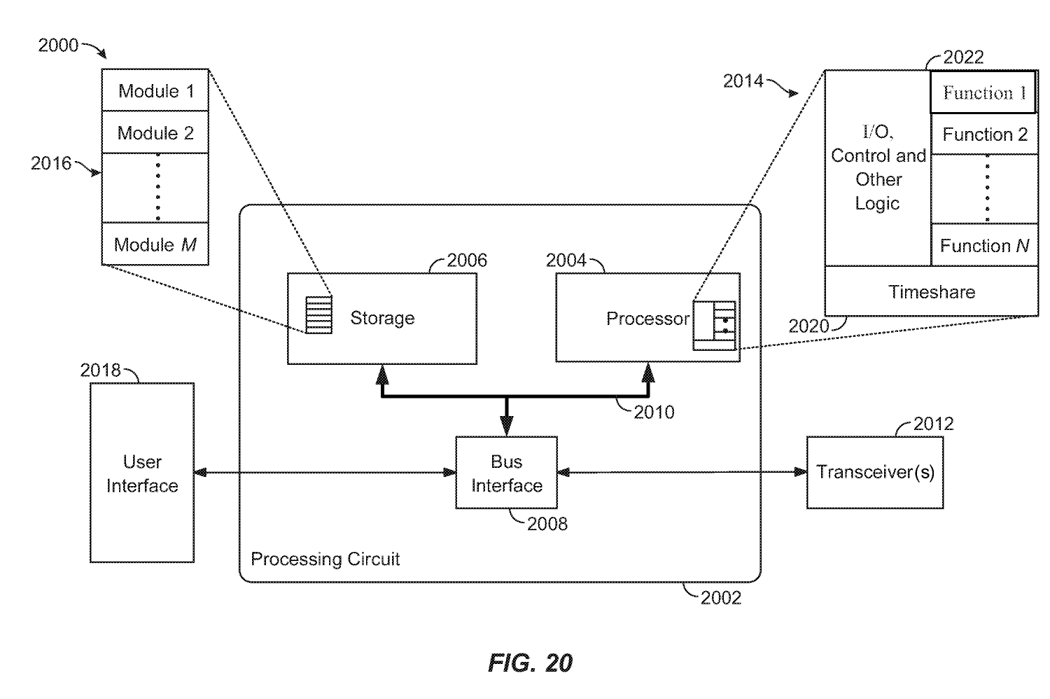

FIG. 20 is a conceptual diagram 2000 illustrating a simplified example of a hardware implementation for an apparatus employing a processing circuit 2002 that may be configured to perform one or more functions in accordance with aspects of the present disclosure. In accordance with various aspects of the disclosure, an element, or any portion of an element, or any combination of elements as disclosed herein may be implemented utilizing the processing circuit 2002. The processing circuit 2002 may include one or more processors 2004 that are controlled by some combination of hardware and software modules. Examples of processors 2004 include microprocessors, microcontrollers, digital signal processors (DSPs), field programmable gate arrays (FPGAs), programmable logic devices (PLDs), state machines, sequencers, gated logic, discrete hardware circuits, and other suitable hardware configured to perform the various functionality described throughout this disclosure. The one or more processors 2004 may include specialized processors that perform specific functions, and that may be configured, reformatted or controlled by one of the software modules 2016. In various aspects, the software modules 2016 may include an egress module, an ingress module and/or a routing module for performing one or more of the features and/or steps in the flow diagrams of FIGS. 10 and 11.

The one or more processors 2004 may be configured through a combination of software modules 2016 loaded during initialization, and further configured by loading or unloading one or more software modules 2016 during operation.

In the illustrated example, the processing circuit 2002 may be implemented with a bus architecture, represented generally by the bus 2010. The bus 2010 may include any number of interconnecting buses and bridges depending on the specific application of the processing circuit 2002 and the overall design constraints. The bus 2010 links together various circuits including the one or more processors 2004 (a.k.a. the at least one processor), and storage 2006. Storage 2006 may include memory devices and mass storage devices, and may be referred to herein as computer-readable storage media and/or processor-readable storage media. The computer-readable storage media may include computer executable code which may include instructions for causing the at least one processor to perform certain functions. The bus 2010 may also link various other circuits such as timing sources, timers, peripherals, voltage regulators, and power management circuits. A bus interface 2008 may provide an interface between the bus 2010 and one or more transceivers 2012. A transceiver 2012 may be provided for each networking technology supported by the processing circuit. In some instances, multiple networking technologies may share some or all of the circuitry or processing modules found in a transceiver 2012. Each transceiver 2012 provides a means for communicating with various other apparatus over a transmission medium. Depending upon the nature of the apparatus, a user interface 2018 (e.g., keypad, display, speaker, microphone, joystick) may also be provided, and may be communicatively coupled to the bus 2010 directly or through the bus interface 2008.

A processor 2004 may be responsible for managing the bus 2010 and for general processing that may include the execution of software stored in a computer-readable storage medium that may include the storage 2006. In this respect, the processing circuit 2002, including the processor 2004, may be used to implement any of the methods, functions and techniques disclosed herein. The storage 2006 may be used for storing data that is manipulated by the processor 2004 when executing software, and the software may be configured to implement any one of the methods disclosed herein.

One or more processors 2004 in the processing circuit 2002 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 2006 or in an external computer-readable storage medium. The external computer-readable storage medium and/or storage 2006 may include a non-transitory computer-readable storage medium. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium and/or storage 2006 may also include, by way of example, a carrier wave, a transmission line, and any other suitable medium for transmitting software and/or instructions that may be accessed and read by a computer. Computer-readable storage medium and/or the storage 2006 may reside in the processing circuit 2002, in the processor 2004, external to the processing circuit 2002, or be distributed across multiple entities including the processing circuit 2002. The computer-readable storage medium and/or storage 2006 may be embodied in a computer program product. By way of example, a computer program product may include a computer-readable storage medium in packaging materials. Those skilled in the art will recognize how best to implement the described functionality presented throughout this disclosure depending on the particular application and the overall design constraints imposed on the overall system.

The storage 2006 may maintain software maintained and/or organized in loadable code segments, modules, applications, programs, etc., which may be referred to herein as software modules 2016. Each of the software modules 2016 may include instructions and data that, when installed or loaded on the processing circuit 2002 and executed by the one or more processors 2004, contribute to a run-time image 2014 that controls the operation of the one or more processors 2004. When executed, certain instructions may cause the processing circuit 2002 to perform functions in accordance with certain methods, algorithms and processes described herein. In various aspects, each of the functions is mapped to the features and/or steps disclosed in one or more blocks of FIGS. 10 and 11.

Some of the software modules 2016 may be loaded during initialization of the processing circuit 2002, and these software modules 2016 may configure the processing circuit 2002 to enable performance of the various functions disclosed herein. In various aspects, each of the software modules 2016 is mapped to the features and/or steps disclosed in one or more blocks of FIGS. 10 and 11. For example, some software modules 2016 may configure input/output (I/O), control and other logic 2022 of the processor 2004, and may manage access to external devices such as the transceiver 2012, the bus interface 2008, the user interface 2018, timers, mathematical coprocessors, and so on. The software modules 2016 may include a control program and/or an operating system that interacts with interrupt handlers and device drivers, and that controls access to various resources provided by the processing circuit 2002. The resources may include memory, processing time, access to the transceiver 2012, the user interface 2018, and so on.

One or more processors 2004 of the processing circuit 2002 may be multifunctional, whereby some of the software modules 2016 are loaded and configured to perform different functions or different instances of the same function. The one or more processors 2004 may additionally be adapted to manage background tasks initiated in response to inputs from the user interface 2018, the transceiver 2012, and device drivers, for example. To support the performance of multiple functions, the one or more processors 2004 may be configured to provide a multitasking environment, whereby each of a plurality of functions is implemented as a set of tasks serviced by the one or more processors 2004 as needed or desired. In various examples, the multitasking environment may be implemented utilizing a timesharing program 2020 that passes control of a processor 2004 between different tasks, whereby each task returns control of the one or more processors 2004 to the timesharing program 2020 upon completion of any outstanding operations and/or in response to an input such as an interrupt. When a task has control of the one or more processors 2004, the processing circuit is effectively specialized for the purposes addressed by the function associated with the controlling task. The timesharing program 2020 may include an operating system, a main loop that transfers control on a round-robin basis, a function that allocates control of the one or more processors 2004 in accordance with a prioritization of the functions, and/or an interrupt driven main loop that responds to external events by providing control of the one or more processors 2004 to a handling function. In various aspects, the functions depicted as Function 1 through Function N in the run-time image 2014 may include one or more of the features and/or steps disclosed in the flow diagrams of FIGS. 10 and 11.

In various examples, the methods of flow diagrams 1000 and 1100 may be implemented by one or more of the exemplary systems illustrated in FIGS. 15-20. In various examples, the methods of flow diagrams 1000 and 1100 (shown in FIGS. 10-11) may be implemented by any other suitable apparatus or means for carrying out the described functions.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), cdma2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

One or more processors in the processing system may execute software. Software may be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a transmission line and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for Enhanced Voice Services (EVS) encoding, comprising:
encoding an audio signal to obtain an encoded audio signal and a bitrate associated with the encoded audio signal;
establishing a source format for the encoded audio signal based on the bitrate; and
reformatting the encoded audio signal with a pre-selected pattern to generate a packet, wherein a capacity of the packet is based on the source format.

2. The method of claim 1, further comprising generating the audio signal, wherein the audio signal is generated by one of the following: a microphone, an audio player, a transducer or a speech synthesizer.

3. The method of claim 2, further comprising:
modulating the packet to generate a modulated waveform; and
transmitting the modulated waveform to an audio destination, wherein the audio destination is an audio consumer.

4. The method of claim 1, wherein the pre-selected pattern includes one of the following: one or more zero-fill bits, one or more one-fill bits, or an arbitrary group of bits.

5. The method of claim 1, wherein the source format is a radio configuration (RC) for cdma2000 1×.

6. The method of claim 5, wherein the radio configuration (RC) is a physical channel configuration based on a channel data rate that includes one or more of the following: forward error correction (FEC) parameters, modulation parameters and spreading factors.

7. The method of claim 1, wherein the audio signal is either a speech signal or a music signal.

8. The method of claim 1, wherein the audio signal is supported in one of the following: supported bandwidths: a narrowband (NB); a wideband (WB), a super wideband (SWB) or a full band (FB).

9. The method of claim 8, wherein the audio signal is supported over an audio frequency range between 0 kHz to 20 kHz.

10. The method of claim 8, wherein the bitrate is an Enhanced Voice Services (EVS) bitrate that is mapped into the one of the supported bandwidths that support the audio signal.

11. The method of claim 1, wherein the encoded audio signal is one of the following: an Enhanced Voice Services (EVS) Source Controlled Variable Bit Rate (SC-VBR) at 5.9 kbps, an Enhanced Voice Services (EVS) Super Wideband (SWB) channel aware mode (ch-aw mode) at 13.2 kbps or an Enhanced Voice Services (EVS) packet.

12. The method of claim 1, wherein the packet includes one or more of the following: reserved bits, flag bits, erasure bits or encoder tail bits.

13. A method for Enhanced Voice Services (EVS) decoding, comprising:
obtaining a data rate associated with a packet;
discarding one or more pre-selected patterns from the packet to recover an encoded audio signal based on the data rate; and
decoding the encoded audio signal to generate a decoded audio signal.

14. The method of claim 13, further comprising:
receiving a signal; and
converting the received signal to the packet.

15. The method of claim 14, further comprising sending the decoded audio signal to an audio destination, wherein the audio destination is one of the following: a speaker, a headphone, a recording device or a digital storage device.

16. The method of claim 13, wherein the one or more pre-selected pattern includes one of the following: one or more zero-fill bits, one or more one-fill bits, or an arbitrary group of bits.

17. The method of claim 13, wherein the decoded audio signal is a speech signal or a music signal.

18. The method of claim 13, wherein the decoded audio signal is supported in one of the following: supported bandwidths: a narrowband (NB); a wideband (WB), a super wideband (SWB) or a full band (FB).

19. The method of claim 18, wherein the decoded audio signal is supported over an audio frequency range between 0 kHz to 20 kHz.

20. The method of claim 13, wherein the packet includes one or more of the following: reserved bits, flag bits, erasure bits or encoder tail bits.

21. A method for interworking, comprising:
receiving an encoded audio signal and a bitrate associated with the encoded audio signal from a first network without discontinuous transmission (DTX) support;
discarding a pre-selected pattern from the encoded audio signal to generate a packet for a second network with DTX support, wherein the pre-selected pattern is based on the DTX support; and
sending the packet to the second network.

22. A method for interworking, comprising:
receiving an encoded audio signal and a bitrate associated with the encoded audio signal from a first network with discontinuous transmission (DTX) support;
reformatting the encoded audio signal with a pre-selected pattern to generate a packet for a second network without DTX support, wherein the pre-selected pattern is based on the DTX support; and
sending the packet to the second network.

23. An apparatus for Enhanced Voice Services (EVS) encoding, comprising:
means for encoding an audio signal to obtain an encoded audio signal and a bitrate associated with the encoded audio signal;
means for establishing a source format for the encoded audio signal based on the bitrate; and
means for reformatting the encoded audio signal with a pre-selected pattern to generate a packet, wherein a capacity of the packet is based on the source format.

24. The apparatus of claim 23, further comprising:
means for modulating the packet to generate a modulated waveform; and
means for transmitting the modulated waveform to an audio destination, wherein the audio destination is an audio consumer.

25. An apparatus for Enhanced Voice Services (EVS) decoding, comprising:
means for obtaining a data rate associated with a packet;
means for discarding one or more pre-selected patterns from the packet to recover an encoded audio signal based on the data rate; and
means for decoding the encoded audio signal to generate a decoded audio signal.

26. The apparatus of claim 25, further comprising means for sending the decoded audio signal to an audio destination, wherein the audio destination is one of the following: a speaker, a headphone, a recording device or a digital storage device.

27. An apparatus for interworking, comprising:
means for receiving an encoded audio signal and a bitrate associated with the encoded audio signal from a first network without discontinuous transmission (DTX) support;
means for discarding a pre-selected pattern from the encoded audio signal to generate a packet for a second network with DTX support, wherein the pre-selected pattern is based on the DTX support; and
means for sending the packet to the second network.

28. An apparatus for interworking, comprising:
means for receiving an encoded audio signal and a bitrate associated with the encoded audio signal from a first network with discontinuous transmission (DTX) support;
means for reformatting the encoded audio signal with a pre-selected pattern to generate a packet for a second network without DTX support, wherein the pre-selected pattern is based on the DTX support; and
means for sending the packet to the second network.

29. A computer-readable storage medium storing computer executable code, operable on a device comprising at least one processor; a memory for storing a sharing profile, the memory coupled to the at least one processor; and the computer executable code comprising:
instructions for causing the at least one processor to encode an audio signal to obtain an encoded audio signal and a bitrate associated with the encoded audio signal;
instructions for causing the at least one processor to establish a source format for the encoded audio signal based on the bitrate; and
instructions for causing the at least one processor to reformat the encoded audio signal with a pre-selected pattern to generate a packet, wherein a capacity of the packet is based on the source format.

30. A computer-readable storage medium storing computer executable code, operable on a device comprising at least one processor; a memory for storing a sharing profile, the memory coupled to the at least one processor; and the computer executable code comprising:
instructions for causing the at least one processor to obtain a data rate associated with a packet;
instructions for causing the at least one processor to discard one or more pre-selected patterns from the packet to recover an encoded audio signal based on the data rate; and
instructions for causing the at least one processor to decode the encoded audio signal to generate a decoded audio signal.
